(19) United States
(12) Patent Application Publication
(10) Pub. No.: US 2022/0298441 A1
(43) Pub. Date: Sep. 22, 2022

(54) METHOD FOR PRODUCING FUEL USING RENEWABLE METHANE

(71) Applicant: Iogen Corporation, Ottawa (CA)

(72) Inventor: Patrick J. Foody, Ottawa (CA)

(21) Appl. No.: 17/637,210

(22) PCT Filed: Aug. 27, 2020
(86) PCT No.: PCT/CA2020/051168

§ 371 Date: Feb. 22, 2022

Related U.S. Application Data
(60) Provisional application No. 63/018,012, filed on Apr. 30, 2020.
(60) Provisional application No. 62/892,123, filed on Aug. 27, 2019.

(51) Int. Cl. C10L 1/06; C10L 1/08; C10G 47/00; C10G 49/00

(52) U.S. Cl. CPC C10L 1/06; C10L 1/08; C10G 47/00; C10G 49/007; C10L 2200/0469; C10G 2400/02; C10G 2400/04; C10G 2400/08

(57) ABSTRACT

A method of producing one or more fuels having a renewable content from a fuel production process that includes one or more processing steps wherein hydrogen is reacted with crude oil derived liquid hydrocarbon, where the hydrogen is produced by a plurality of hydrogen production units based on steam methane reforming. The method includes selecting one or more hydrogen production units from the plurality of hydrogen production units which have one or more hydrogen-producing characteristics, and allocating renewable methane such that a renewable fraction of feedstock for the selected hydrogen production units is greater than a renewable fraction of feedstock for other hydrogen production units. The selected hydrogen production units are selected to increase a yield of renewable content of one or more of the fuels produced by the fuel production process and/or reduce a carbon intensity of such fuels for a given quantity of renewable methane.

### TECHNICAL FIELD

The present invention generally relates to a method and/or system for producing one or more fuels using renewable methane and/or renewable hydrogen, and more specifically, to a method and/or system for producing one or more fuels wherein crude oil derived hydrocarbon is co-processed with renewable methane and/or renewable hydrogen.

### BACKGROUND

Conventionally, fuels such as gasoline, jet fuel, and diesel are produced at oil refineries, where crude oil is converted through numerous unit operations and conversion reactions into the various fuels. Today there is a growing interest in supplementing or supplanting such fossil-based fuels with renewable fuels. For example, conventional gasoline may be blended with renewable ethanol (e.g., E10, E15, or E85 blends), while conventional diesel may be blended with biodiesel (e.g., B2 or B7 blends).

Biodiesel refers to a renewable fuel consisting of fatty acid methyl esters (FAME). For example, biodiesel may be produced by transesterification of vegetable oil (e.g., soybean oil, canola oil, corn oil, rapeseed oil, sunflower oil, palm oil), algal oil, tall oil, fish oil, animal fats, used cooking oils, hydrogenated vegetable oils, or any mixture thereof, with an alcohol, in the presence of a catalyst. While biodiesel generally has gained acceptance as a blendstock for producing lower blends (e.g., B2 or B7 blends), pure biodiesel (B100) is rarely used directly as a transportation fuel.

Alternatively, vegetable oil, algal oil, animal fats, or oil derived from biomass, may be hydroprocessed to produce a renewable fuel. For example, biomass can be subjected to a pyrolysis process that produces bio oil. Hydrotreatment of this bio oil (i.e., biomass-derived oil), including hydrodeoxygenation (HDO), hydrodesulfurization (HDS), and olefin hydrogenation, may produce a gasoline or diesel substitute suitable for use as a renewable blendstock (e.g., for blending or use as standalone fuel). Diesel resulting from the hydroprocessing of renewably sourced oils is often called “renewable diesel” to distinguish it from biodiesel. Compared with biodiesel, renewable diesel is generally considered to have better fuel properties. In contrast to biodiesel, renewable diesel is typically fungible with conventional diesel, so it can be blended at much higher levels than biodiesel.

While renewable fuels produced from renewably sourced oils (e.g., biodiesel, renewable diesel, or renewable gasoline) continue to attract attention, they are not ideal. For example, some disadvantages include the cost of feedstock (e.g., vegetable oil or bio oil), a limited supply of feedstock (e.g., particularly when compared to crude oil), adverse impacts of increased land use towards such fuels, and/or concerns related to competition with food production.

One approach to produce gasoline and diesel from a renewable resource other than renewably sourced oils is to use a Fischer-Tropsch synthesis. The Fischer-Tropsch process converts a mixture of hydrogen (H₂) and carbon monoxide (CO) (e.g., syngas) to liquid hydrocarbons. The syngas may be obtained by steam reforming biogas, or from gasification of biomass. In general, Fischer-Tropsch derived diesel product (FT diesel) is high quality fuel, free of sulfur and fungible with conventional diesel. However, such processes are relatively expensive.

Yet another approach to produce fuel, such as gasoline and diesel, from a renewable resource is to use biogas to generate renewable hydrogen, and to use the renewable hydrogen to hydrogenate crude oil derived hydrocarbons in a fuel production process to make renewable or partially renewable fuel (e.g., see U.S. Pat. Nos. 8,658,026, 8,753,854, 8,945,373, 9,040,271, 10,093,540). In this approach, gasoline, diesel, and/or jet fuel (e.g., co-processed diesel originating from biomass) may be produced using existing fuel production facilities. Advantageously, this approach can increase a fossil fuel refiner's capability to produce renewable fuels and/or expand the use of biogas.

### SUMMARY

Disclosed herein is a method and/or system wherein renewable methane and/or renewable hydrogen is co-processed with crude oil derived liquid hydrocarbon, thereby producing one or more fuels having renewable content. While it is generally advantageous to produce fuel having renewable content, it can be challenging to comply with various standards and/or regulations that support renewable energy targets and/or sustainability goals. For example, it can be challenging to meet annual volume requirements and/or greenhouse gas (GHG) emission reductions set by various regulatory agencies for transportation fuels. The instant disclosure provides a method and/or system that can increase the renewable content produced by the fuel production facility and/or reduce the carbon intensity of the fuels produced from the fuel production process, for a given amount of renewable methane and/or RNG.

In particular, it has been found that for fuels made by coprocessing renewable methane and/or renewable hydrogen with crude oil derived hydrocarbon, the yield of renewable content in one or more of the fuels produced can be increased and/or the carbon intensity of such fuels reduced when certain hydrogen production units are selected over others and greater amounts of renewable methane are allocated to the selected hydrogen production units. In particular, it has been found that the yield of renewable content and/or carbon intensity of the renewable content is dependent on various characteristics of the hydrogen production units, including whether a unit has a particular style of configuration (e.g., “newer” or an “older” style) and/or whether the unit is on-site or off-site.

Thus, provided in certain embodiments herein is a method for coprocessing renewable and non-renewable feedstock to produce fuel, the coprocessing carried out at a facility having a plurality of hydrogen production units, at least one of which has a different location and/or configuration than the others, the method comprising introducing renewable methane and/or RNG to at least one of the units that has been allocated to achieve an increase in renewable content and/or a reduced carbon intensity of such fuel. The method may include various embodiments and alternatives described herein.

In accordance with one aspect of the instant invention there is provided a method of producing one or more fuels comprising: (a) providing a feedstock for a fuel production process that produces one or more fuels, said feedstock comprising methane, a fraction of which is renewable methane, said fuel production process comprising one or more processing steps wherein hydrogen is reacted with crude oil derived liquid hydrocarbon, said hydrogen produced by steam methane reforming in a plurality of hydrogen production units; (b) producing one or more fuels from the fuel production process using the feedstock; (c) providing a volume of a fuel produced from the fuel production process, said fuel comprising renewable content, wherein the volume of the fuel, the renewable content, or a combination thereof is dependent on a calculated renewable content, said calculated renewable content dependent on allocating the renewable methane such that a renewable fraction of a feedstock for one or more selected hydrogen production units is greater than a renewable fraction of a feedstock for one or more other hydrogen production units, and wherein the one or more selected hydrogen production units and the one or more other hydrogen production unit are selected from the plurality of hydrogen production units.

In accordance with one aspect of the instant invention there is provided a method of producing one or more fuels comprising: (a) providing a feedstock comprising natural gas, a fraction of which is renewable natural gas; (b) producing one or more fuels in a fuel production process, said fuel production process comprising one or more processing steps wherein hydrogen is reacted with crude oil derived liquid hydrocarbon, said hydrogen produced by providing the feedstock to a plurality of hydrogen production units; (c) allocating the renewable natural gas as feedstock to one or more hydrogen production units in the plurality of hydrogen production units, wherein allocating the renewable natural gas comprises preferentially allocating the renewable natural gas to older style hydrogen production units over newer style hydrogen production units, preferentially allocating the renewable natural gas to on-site hydrogen production units over off-site hydrogen production units, or a combination thereof; and (d) providing a fuel having renewable content, said renewable content quantified in dependence upon the allocating in step (c).

In accordance with one aspect of the instant invention there is provided a method of producing one or more fuels comprising: (a) providing a feedstock for a fuel production process that produces one or more fuels, said feedstock comprising natural gas, a fraction of which is renewable natural gas, said fuel production process comprising one or more processing steps wherein hydrogen is reacted with crude oil derived liquid hydrocarbon, said hydrogen produced by methane reforming in a plurality of hydrogen production units, said plurality of hydrogen production units comprising an off-site hydrogen production unit, a hydrogen production unit comprising a pressure swing adsorption system, or a combination thereof; (b) producing one or more fuels from the fuel production process using the feedstock; (c) allocating the renewable natural gas to one or more selected hydrogen production units in the plurality of production units such that a renewable fraction of the feedstock fed to each of the one or more selected hydrogen production units is greater than a renewable fraction of feedstock for all hydrogen production for the fuel production process, wherein the one or more selected hydrogen production units include an on-site hydrogen production unit, a hydrogen production unit comprising an absorption-based hydrogen purification system, or combination thereof; (d) providing a volume of a fuel produced from the fuel production process, said fuel comprising renewable content, wherein the volume of the fuel, the renewable content, or a combination thereof is dependent on which hydrogen production units are selected from the plurality of hydrogen units.

In accordance with one aspect of the instant invention there is provided a method of producing one or more fuels comprising: (a) providing natural gas, a fraction of which is renewable, for producing renewable hydrogen for use in a fuel production facility, said fuel production facility comprising one or more hydrogenation reactors and having a pipe system configured to convey hydrogen produced at a plurality of hydrogen production units, said plurality of hydrogen production units comprising a first hydrogen production unit comprising a pressure swing adsorption system, a second hydrogen production located off-site, or combination thereof; (b) directing at least some of the renewable natural gas provided in step (a) to one or more hydrogen production units selected from the plurality of hydrogen production units, each of said hydrogen production units selected over at least one of the first and second hydrogen production units such that a renewable fraction of feedstock for each selected hydrogen production unit is higher than renewable fraction of feedstock for the first or second hydrogen production unit; (c) feeding renewable hydrogen produced using the renewable natural gas provided in step (a) to the one or more the one or more hydrogenation reactors using the pipe system and hydrogenating crude oil derived liquid hydrocarbon in the one or more hydrogenation reactors; (d) providing a fuel comprising crude oil derived liquid hydrocarbon hydrogenated with the renewable hydrogen in step (c), and (e) determining a renewable content of the fuel provided in step (d), a carbon intensity of the fuel provided in step (d), or a combination thereof, wherein the renewable content of the fuel, carbon intensity of the fuel, or combination thereof, is dependent on the feedstock for each selected hydrogen production unit having a higher renewable fraction than the feedstock for the first or second hydrogen production unit.

### BRIEF DESCRIPTION OF THE DRAWINGS

FIG. 1 is a representative simplified process flow diagram of some major processing units in an oil refinery, according to one embodiment;

FIG. 2 is a flow diagram illustrating an embodiment wherein a fuel is produced using renewable methane;

FIG. 3a is a simplified flow diagram for an older style hydrogen production unit using SMR;

FIG. 3b is a simplified flow diagram for a newer style hydrogen production unit using SMR;

FIG. 4 is a schematic diagram of a system in which one or more fuel(s) having renewable content can be produced in accordance with one embodiment of the invention; and

FIG. 5 is a schematic diagram illustrating different boundaries of a fuel production process.

### DETAILED DESCRIPTION

Certain exemplary embodiments of the invention now will be described in more detail, with reference to the drawings, in which like features are identified by like reference numerals. The invention may, however, be embodied in many different forms and should not be construed as limited to the embodiments set forth herein.

The terminology used herein is for the purpose of describing certain embodiments only and is not intended to be limiting of the invention. For example, as used herein, the singular forms “a,” “an,” and “the” may include plural references unless the context clearly dictates otherwise. The terms “comprises”, “comprising”, “including”, and/or “includes”, as used herein, are intended to mean “including but not limited to.” The term “and/or”, as used herein, is intended to refer to either or both of the elements so conjoined. The phrase “at least one” in reference to a list of one or more elements, is intended to refer to at least one element selected from any one or more of the elements in the list of elements, but not necessarily including at least one of each and every element specifically listed within the list of elements. Thus, as a non-limiting example, the phrase “at least one of A and B” may refer to at least one A with no B present, at least one B with no A present, or at least one A and at least one B in combination. The terms “cause” or “causing”, as used herein, may include arranging or bringing about a specific result (e.g., a withdrawal of a gas), either directly or indirectly, or to play a role in a series of activities through commercial arrangements such as a written agreement, verbal agreement, or contract. The term “associated with”, as used herein with reference to two elements (e.g., a fuel credit associated with the transportation fuel), is intended to refer to the two elements being connected with each other, linked to each other, related in some way, dependent upon each other in some way, and/or in some relationship with each other. The term “plurality”, as used herein, refers to two or more. The terms “upstream” and “downstream”, as used herein, refer to the disposition of a step/stage in the process with respect to the disposition of other steps/stages of the process. For example, the term upstream can be used to describe to a step/stage that occurs at an earlier point of the process, whereas the term downstream can be used to describe a step/stage that occurs later in the process. Unless defined otherwise, all technical and scientific terms used herein have the same meanings as commonly understood by one of ordinary skill in the art.

Oil refineries (i.e., petroleum refineries) include many unit operations and processes. One of the first unit operations is the continuous distillation of crude oil. For example, crude oil may be desalted and piped through a hot furnace before being fed into a distillation unit (e.g., an atmospheric distillation unit or vacuum distillation unit). Inside the distillation unit, the liquids and vapours separate into fractions in dependence upon their boiling point. The lighter fractions, including naphtha, rise to the top, the middle fractions, including kerosene and diesel/heating oil, stay in the middle, and the heavier liquids, often called gas oil, settle at the bottom. After distillation, each of the fractions may be further processed (e.g., in a cracking unit, a reforming unit, alkylation unit, light ends unit, dewaxing unit, coking unit, etc.). The term “unit,” as used herein, generally refers to one or more systems that perform a unit operation. Unit operations can involve a physical change and/or chemical transformation. A unit can include one or more individual components. For example, a separation unit can include more than one separation column, while a hydrogen production unit can include one or more methane reformers.

Cracking units use heat, pressure, catalysts, and sometimes hydrogen, to crack heavy hydrocarbon molecules into lighter ones. Complex refineries may have multiple types of crackers, including fluid catalytic cracking (FCC) units and/or hydrocracking units. FCC units (i.e., catalytic crackers or “cat crackers”) are often used to process gas oil from distillation units. The FCC process primarily produces gasoline, but may also produce important by-products such as liquefied petroleum gas (LPG), light olefins, light cycle oil (LCO), heavy cycle oil (HCO), and clarified slurry oil. Hydrocracking units (i.e., hydrocrackers), which consume hydrogen, may be also used to process gas oils from a distillation unit. However, since the hydrocracking process combines hydrogenation and catalytic cracking, it may be able to handle feedstocks that are heavier than those that can be processed by FCC, and thus may be used to process oil from cat crackers or coking units. Hydrocrackers typically produce more middle distillates (e.g., kerosene and/or diesel) than gasoline. Hydrocrackers may also hydrogenate unsaturated hydrocarbons and any sulfur, nitrogen or oxygen compounds (e.g., reduces sulfur and nitrogen levels).

Reforming units (i.e., catalytic reforming units) use heat, moderate pressure, and catalysts to convert heavy naphtha, which typically has a low octane rating, and/or other low octane gasoline fractions, into high-octane gasoline components called reformates. Alkylation units may convert lighter fractions (e.g., by-products of cracking) into gasoline components. Isomerization units may convert linear molecules to higher-octane branded molecules for blending into gasoline or as feedstock to alkylation units.

Hydrotreating units may perform a number of diverse processes including, for example, the conversion of benzene to cyclohexane, aromatics to naphtha, and the reduction of sulfur, oxygen, and/or nitrogen levels. For example, hydrotreating units are often used to remove sulfur from naphtha streams because sulfur, even in very low concentrations, may poison the catalysts in catalytic reforming units. In oil refineries, hydrotreaters are often referred to as hydrodesulfurization (HDS) units. Hydrotreating units may be used for kerosene, diesel, and/or gas oil fractions. For example, hydrotreating units for diesel may saturate olefins, thereby improving the cetane number.

Both hydrotreating and hydrocracking fall within the scope of the term “hydroprocessing” and consume hydrogen. In general, hydrotreating is less severe than hydrocracking (e.g., there is minimal cracking associated with hydrotreating). For example, the time that the feedstock remains at the reaction temperature and the extent of decomposition of non-heteroatoms may differ between hydrotreating and hydrocracking. Hydroprocessing is typically conducted in a hydroprocessing unit. The term “hydroprocessing unit”, as used herein, refers to one or more systems (e.g., hydrogenation reactor(s), pumps, compressor(s), separation equipment, etc.) provided for hydroprocessing operations. For example, hydrotreating units and hydrocracking units are examples of hydroprocessing units.

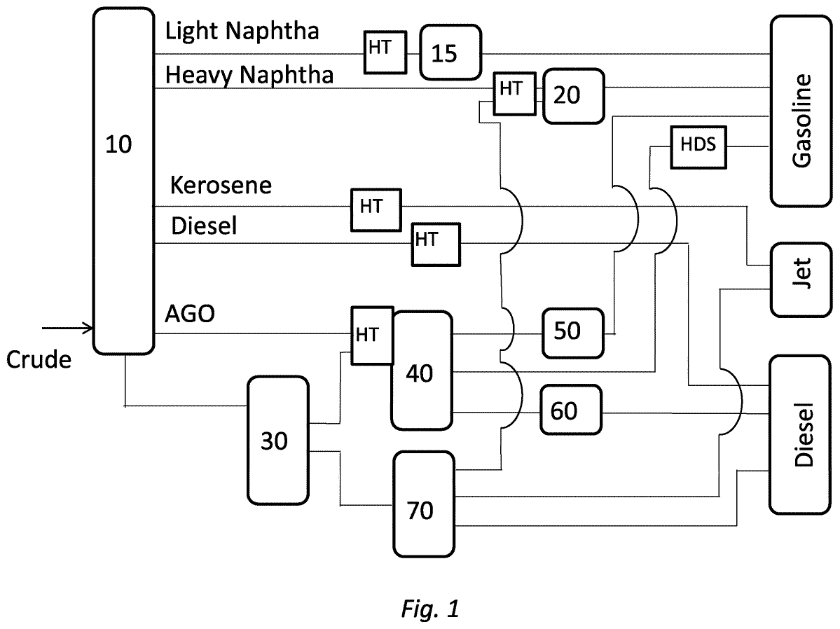

Referring to FIG. 1, there is shown some of the unit operations commonly found in an oil refinery. The crude oil, supplied by a suitable furnace (not shown), is introduced into an atmospheric distillation unit 10, where it is separated into different fractions: atmospheric gas oil (AGO), diesel, kerosene, and naphtha (light and heavy). Light naphtha is directed to an isomerization unit 15 to produce isomerate. Heavy naphtha is directed to a reformer 20 to produce reformate. Residue from the atmospheric distillation process (atmospheric bottoms) is fed to a vacuum distillation unit 30, which produces light vacuum gas oil (LVGO) and heavy vacuum gas oil (HVGO). The AGO and/or LVGO are fed to the FCC 40. The FCC 40 produces, for example, propylene and butylenes, which are fed to an alkylation unit 50. The FCC 50 also produces gasoline (i.e., FCC gasoline) and light cycle oil (LCO). LCO, which is a diesel boiling range product, is a poor diesel fuel blending component without further processing. In FIG. 1, the LCO is fed to a hydrocracker 60; however, other approaches to upgrading LCO may be used. The HVGO is fed to the hydrocracker 70, where it is processed into naphtha, kerosene, and/or diesel. The hydrocracker naphtha may contain naphthene, and thus may be converted to high-octane grade gasoline upon catalytic reforming 20. In general, the hydrocracker products may have a low content of sulfur and/or contaminants.

Referring again to FIG. 1, the various outputs from these unit operations/process units may be blended to provide fuels (e.g., finished fuels) and/or be part of various pools (e.g., gasoline, jet fuel, diesel/heating oil). For example, in FIG. 1, isomerate from the isomerization unit 15, reformate from the reformer 20, alkylate from the alkylation unit 50, and FCC gasoline from the FCC 50 may be part of the gasoline pool, while the straight run diesel (i.e., from the atmospheric crude tower 10), the hydrocracked diesel, and the light cycle oil from the FCC may be part of the diesel pool (e.g., after further processing). Depending on the grade, jet fuel can be largely highly refined kerosene. The term “pool”, as used herein, refers to all of the fuel produced by the fuel production process that is ultimately sold as the corresponding fuel pool (e.g., over a given time period). For example, the gasoline pool typically includes all the gasoline boiling range fuels that are ultimately sold as gasoline product, but does not include gasoline boiling range fuels that end up in jet fuel. The fuels that contribute to a pool may have different qualities and/or be stored separately.

In general, the boiling point ranges of the various product fractions (e.g., gasoline, kerosene/jet fuel, diesel/heating oil) may be set by the oil refinery and/or may vary with factors such as the characteristics of the crude oil source, refinery local markets, product prices, etc. For example, without being limiting, the gasoline boiling point range may span from about 35° C. to about 200° C., the kerosene boiling point range may span from about 140° C. to about 230° C., and the diesel boiling point range may span from about 180° C. to about 400° C. Each boiling point range covers a temperature interval from the initial boiling point, defined as the temperature at which the first drop of distillation product is obtained, to a final boiling point, or end point, where the highest-boiling compounds evaporate.

Of course, it will be appreciated by those skilled in the art that the flow diagram of FIG. 1 is representative only. In practice, the unit operations, process units, and/or general configuration may be dependent on the oil refinery, the desired fuel products, and/or advancing technologies. For example, the configuration and/or technology may be dependent upon whether the oil refinery is designed to produce more gasoline or diesel. In general, some oil refineries, e.g., those in the United States, often produce more gasoline than diesel, and thus typically include one or more cat crackers. Without being limiting, a typical U.S. refinery may produce about 60% gasoline-fuel components and about 40% diesel/jet fuel components. In some cases, the gasoline to diesel ratio is seasonal and higher in the summer than the winter to reflect changes in fuel demand.

In addition, although not shown in FIG. 1, a typical oil refinery will include a light ends unit (e.g., for processing the overhead distillate produce from the atmospheric distillation column), and may include units for processing vacuum distillation residues (e.g., the bottom of the barrel), polymerization units, coking units, visbreaking units, tanks, pumps, valves, and so forth. In addition, some of the components illustrated in FIG. 1 may be provided in replicate. For example, there may be multiple, independently operated distillation units. Furthermore, oil refineries typically include various auxiliary facilities (e.g., boilers, waste water treatments, hydrogen production units, cooling towers, and sulfur recovery units).

Oil refineries typically include numerous hydroprocessing units (e.g., hydrotreaters and/or hydrocrackers), each of which consumes hydrogen at individual rates, purities, and pressures. For example, referring again to FIG. 1, the diesel fraction obtained from the atmospheric distillation unit 10 may be treated with a hydrotreater (HT) to provide diesel blendstock, whereas naphtha fractions may be hydroprocessed before being sent to the isomerization 15 or catalytic reformer unit 20.

Hydrogen used in these hydroprocessing units may be obtained from a variety of sources. For example, the hydrogen may be provided by one or more hydrogen production units and/or may be a by-product of another chemical process (e.g., one important source of hydrogen in an oil refinery may be the reforming unit 20, which when used to produce reformate, also produces hydrogen as a by-product).

In some cases, an oil refinery, may include and/or may be connected to multiple hydrogen production units. For example, when the hydrogen demand for an oil refinery increases, additional hydrogen production units may be installed at the oil refinery (e.g., one or more on-site hydrogen production units) and/or the oil refinery may be configured to receive or otherwise obtain hydrogen produced at one or more off-site hydrogen production units (e.g., purchased from a hydrogen producer). Hydrogen demand may increase, for example, as a result of growth of the oil refinery and/or in response to the increasing demand for diesel and/or more stringent sulfur content regulations. Increasingly, oil refineries are obtaining hydrogen from industrial suppliers (e.g., off-site hydrogen production units), which can produce hydrogen more efficiently and/or cost effectively (e.g., newer technologies and/or economies of scale).

An oil refinery that uses hydrogen produced by multiple hydrogen production units typically includes a hydrogen pipe system for conveying hydrogen to the various hydroprocessing units. The term “pipe system”, as used herein, refers to one or more pipes, which may or may not be interconnected (e.g., physically connected), of any length, including any associated pumps and valves. For example, the pipe system in an oil refinery may include multiple pipes, each of which can convey hydrogen produced from a single source of hydrogen, or can convey hydrogen produced from multiple sources of hydrogen (e.g., from a hydrogen production unit and the reforming unit 20).

Steam methane reforming (SMR) of natural gas is a common pathway to supply hydrogen for oil refineries. Unfortunately, SMR is a significant source of fossil carbon dioxide emissions in an oil refinery. These greenhouse gas (GHG) emissions are in addition to the large tailpipe GHG emissions resulting from using the fossil-based fuels as a transportation fuel. While the GHG emissions of an oil refinery may be reduced by using hydrogen produced using electrolysis and/or clean power instead of hydrogen produced from steam methane reforming of natural gas, the instant inventor has recognized that there can be various advantages to using hydrogen produced by steam methane reforming of renewable natural gas as described herein. For example, the carbon dioxide derived from renewable natural gas does not contribute to lifecycle GHG emissions because it is biogenic. In addition, using renewable natural gas provides the opportunity to use existing infrastructure (e.g., renewable natural gas may be co-fed with non-renewable natural gas withdrawn from a distribution system and used as feedstock for the process and/or steam methane reformer) and/or opportunities to use the renewable natural gas in the SMR process as a fuel.

Advantageously, when a feedstock containing renewable methane is provided to a fuel production facility (e.g., an oil refinery), the fuel production process may produce one or more fuels having renewable content (e.g., a co-processed fuel originating from biomass). More specifically, since the one or more fuel(s) are produced by co-processing renewable feedstock (e.g., renewable natural gas) and non-renewable feedstock (e.g., crude oil derived liquid hydrocarbon), at least a portion of the one or more fuel(s) produced can qualify as renewable under applicable regulations (e.g., for fuel credit generation). In this approach, referred to as “co-processing” herein, the renewable content can be determined using any suitable methodology (e.g., mass balance methods or an energy content approach).

Further advantageously, the fuel(s) having renewable content, can have a reduced lifecycle GHG emissions and/or carbon intensity (e.g., relative to the corresponding fossil-based fuel). The term “carbon intensity” or “CI” refers to the quantity of lifecycle greenhouse gas emissions, per unit of fuel energy, which is typically expressed in equivalent carbon dioxide emissions (e.g., gCO₂e/MJ or kgCO₂e/MMBtu). As is known to those skilled in the art, the carbon intensity of a fuel is typically determined using a net lifecycle GHG analysis. A lifecycle GHG analysis, which generally evaluates the GHG emissions of a product and thus can contribute to global warming, typically considers GHG emissions of each: (a) the feedstock production and recovery (including if the carbon in the feedstock is of fossil origin (such as with oil or natural gas) or of atmospheric origin (such as with biomass)), direct impacts like chemical inputs, energy inputs, and emissions from the collection and recovery operations, and indirect impacts like the impact of land use changes from incremental feedstock production; (b) feedstock transport (including energy inputs, and emissions from transport); (c) fuel production (including chemical and energy inputs, emissions and byproducts from fuel production (including direct and indirect impacts)); (d) transport and storage prior to use as a transport fuel (including chemical and energy inputs and emissions from transport and storage), and (e) tailpipe emissions. Models for conducting lifecycle GHG emission analyses are known (e.g., GREET model developed by Argonne National Laboratory (ANL)). As will be understood by those skilled in the art, the lifecycle GHG emissions analysis used to determine the carbon intensity of the fuel can vary and be dependent on the applicable regulations (e.g., for fuel credit generation).

Unfortunately, even when a fuel has renewable content and a reduced carbon intensity (e.g., relative to the corresponding fossil fuel), the fuel may fail to qualify as renewable under applicable regulations (e.g., if it fails to meet a predetermined GHG savings threshold). For example, to qualify as a liquid transportation biofuel under the Renewable Energy Directive (RED) of the European Commission, a fuel must be associated with a 60% or higher GHG savings compared to the fossil fuel counterpart. This threshold increases to at least 65% in 2021.

With specific regard to fuel(s) produced by hydrogenating crude oil derived liquid hydrocarbon with hydrogen including renewable hydrogen, for some oil refineries, the window for the fuel(s) to meet the required GHG savings to qualify as a renewable transportation fuel can be narrow. Given this narrow window and/or increasing strict GHG savings thresholds, it can be advantageous to decrease the carbon intensity of such fuel(s) for a given quantity of renewable methane used to produce the renewable hydrogen.

As described herein, it has now been found that for a given quantity of renewable methane provided in feedstock to the co-processing fuel production process, that the renewable content and/or carbon intensity of fuel(s) produced, can be dependent on where and/or how the renewable methane is used within the fuel production process. More specifically, it has been found that allocating the renewable methane to one or more selected hydrogen production units as described herein, can decrease the carbon intensity of the fuel(s) having renewable content and/or can increase the renewable content of the fuel(s) produced, for a given amount of renewable methane provided. Decreasing the carbon intensity of a fuel having renewable content (e.g., liquid transportation fuel) can be particularly advantageous when the carbon intensity of the fuel must be below a predetermined value (e.g., set by a regulatory agency) in order to qualify as a renewable fuel (e.g., biofuel) and/or when the carbon intensity of the fuel determines the quantity and/or value of regulatory incentives (e.g., fuel credits) received for a given quantity of the fuel produced.

The instant disclosure relates to a method and/or system for producing one or more fuels having renewable content. The term “renewable content”, as used herein, refers the portion of the fuel(s) that is recognized and/or qualifies as renewable (e.g., a biofuel) under applicable regulations. In general, the fuel(s) are produced at a fuel production facility. The term “fuel production facility”, as used herein, refers to any processing plant or plants used for the processing and/or refining of crude oil or crude oil derived hydrocarbons into more useful products, including but not limited to, fuels (e.g., liquid transportation fuels, fuel intermediates, and/or fuel components). For example, some fuel products that can be produced by a fuel production facility include, but are not limited to, gasoline, diesel, heating oil, kerosene, jet fuels, fuels made from naphtha, fuel oils, and/or liquefied petroleum gas. A fuel production facility can also provide some non-fuel products, including, but not limited to, asphalt, greases, waxes, lubricants, and/or chemicals. In one embodiment, the fuel production facility is an oil refinery. An oil refinery is a fuel production facility that has crude oil as its primary input and produces fuels and other products. In one embodiment, the fuel production facility includes one or more integrated oil refineries.

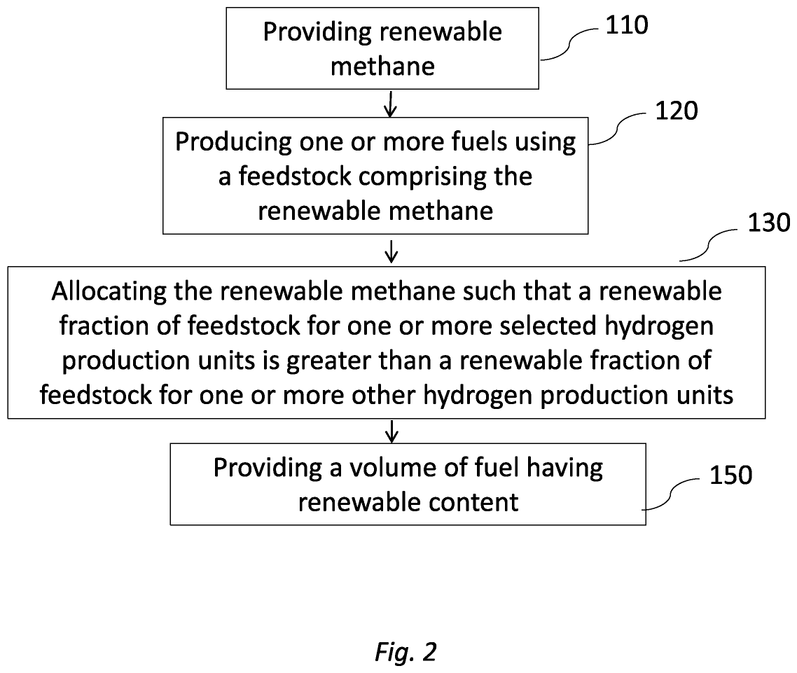

Referring to FIG. 2, there is shown a schematic diagram of one embodiment of the invention. The method includes providing renewable methane (e.g., for producing renewable hydrogen) 110, producing one or more fuels using a feedstock comprising the renewable methane and/or renewable hydrogen 120, allocating the renewable methane such that a renewable fraction of a feedstock for one or more selected hydrogen production units is greater than a renewable fraction of a feedstock for one or more other hydrogen production units 130, and providing a volume of fuel (e.g., gasoline, kerosene, and/or diesel) having renewable content 150.

In this embodiment, the one or more fuels are produced in a fuel production process that includes the hydroprocessing of crude oil derived liquid hydrocarbons. The hydrogen for the hydroprocessing is produced from a plurality of hydrogen production units. Since a feedstock for the fuel production process includes renewable methane and/or renewable hydrogen, one or more of the fuels produced by the fuel production process can have renewable content. The fuel(s) provided in step 150 can be any fuel, including, but not limited to finished fuels (e.g., gasoline, jet fuel, diesel, etc.) or fuel components for blending (e.g., blendstocks such as naphtha, kerosene, diesel, etc.). In one embodiment, the volume of the fuel having renewable content and/or the renewable content is dependent on a calculated renewable content, which is dependent on the renewable methane being allocated such that feedstock for one or more selected hydrogen production units has a renewable fraction of methane that is greater than feedstock for one or more other hydrogen production units. As discussed herein, the method can include allocating the renewable methane such that a renewable fraction of the feedstock for one or more of the selected hydrogen production units is greater than a renewable fraction of feedstock for one or more other hydrogen production units. For example, in one embodiment, the renewable methane is allocated such that a) the renewable fraction of a feedstock for a selected hydrogen production unit is greater than the renewable fraction of a feedstock for one of the other hydrogen production units, b) the renewable fraction of a feedstock fed a system including a plurality of selected hydrogen production units is greater than the renewable fraction of a feedstock of one of the other hydrogen production units, and/or c) the renewable fraction of the feedstock for a system including a plurality of selected hydrogen production units is greater than the renewable fraction of a feedstock fed to another system including a plurality of other hydrogen production units.

In one embodiment, the renewable methane is allocated such that the renewable fraction of the feedstock for one or more selected hydrogen production units is greater than a renewable fraction of feedstock for all hydrogen production for the fuel production process. It can be particularly advantageous to allocate the renewable methane such that the renewable fraction of the feedstock for one or more hydrogen production units having a specific hydrogen-producing characteristic is greater than the renewable fraction of a feedstock for one or more other hydrogen production units not having this hydrogen-producing characteristic (e.g., having a different hydrogen-producing characteristic). A hydrogen-producing characteristic is a specific characteristic of a hydrogen production unit that has an effect on the renewable content and/or carbon intensity of fuel produced using renewable hydrogen generated by that hydrogen production unit.- For example, in one embodiment, the hydrogen-producing characteristic is a) proximity to fuel production (e.g., whether the hydrogen production unit is off-site or on-site), b) an older style of hydrogen production (e.g., older versus newer style), c) no recycle of off-gas, d) no adsorption-based hydrogen purification, or e) a specific energy yield for hydrogen. In one embodiment, the renewable methane is allocated such that the renewable fraction of the feedstock for one or more hydrogen production units having one or more hydrogen-producing characteristics is greater than the renewable fraction of a feedstock for one or more other hydrogen production units not having the one or more hydrogen-producing characteristics. In one embodiment, each of the one or more selected hydrogen production units is an older style hydrogen production unit. In one embodiment, each of the one or more selected hydrogen production units is an on-site hydrogen production unit. In one embodiment, each of the one or more selected hydrogen production units is an on-site, older style hydrogen production unit.

### Renewable Methane

In general, renewable methane is methane produced from biomass. When methane is sourced from biomass, and is not sourced from fossil resources (e.g., buried combustible geologic deposits of organic material), it can be considered a biofuel. While the bulk of existing renewable methane may come from processes that capture gas from the anaerobic digestion (AD) of organic material, it is also possible to produce renewable methane from the gasification of biomass. For example, the gasification of biomass may produce syngas, which may be cleaned up, methanated, and separated into methane and carbon dioxide.

In one embodiment, the renewable methane is produced from biogas. Biogas refers to the gas produced by the anaerobic digestion of organic material. Biogas, which is a mixture of gases, is largely made up of methane and carbon dioxide. The methane in biogas is renewable methane. Biogas may be produced by anaerobic digestion that occurs naturally (e.g., in a landfill) or in an engineered environment (e.g., an anaerobic digester). In one embodiment, the renewable methane is produced from one or more landfills. In one embodiment, the renewable methane is produced from one or more anaerobic digestion facilities. In one embodiment, the renewable methane is produced from manure (e.g., dairy or swine).

In general, the renewable methane can be produced from any suitable biomass. In one embodiment, the renewable methane is produced from (i) agricultural crops, (ii) trees grown for energy production, (iii) wood waste and wood residues, (iv) plants (including aquatic plants and grasses), (v) residues, (vi) fibers, (vii) animal wastes and other waste materials, and/or (viii) fats, oils, and greases (including recycled fats, oils, and greases). In one embodiment, the renewable methane is produced from (i) manure, (ii) agricultural by-products, (iii) energy crops, (iv) wastewater sludge, (v) industrial waste, (vi) source separated organics, and/or (vii) municipal solid waste.

In one embodiment, the renewable methane is produced from waste organic material. The term “waste organic material”, as used herein, refers to organic material used as a feedstock in a waste-to-fuel process, where the feedstock qualifies as a waste or residue for fuel credit generation. Waste organic material includes but is not limited to, residues from agriculture, aquaculture, forestry and fisheries, and includes wastes and processing residues (e.g., organic municipal waste, manure, sewage sludge, waste wood, etc.).

In general, the renewable methane is provided for use in producing one or more fuels. The term “providing” as used herein with respect to an element, refers to directly or indirectly obtaining the element and/or making the element available for use.

In one embodiment, the renewable methane is provided as raw biogas. Raw biogas, which refers to biogas collected at its source (e.g., a landfill or anaerobic digester), is largely composed of methane and carbon dioxide, may also contain hydrogen sulfide (H₂S), water (H₂O), nitrogen (N₂), ammonia (NH₃), hydrogen (H₂), carbon monoxide (CO), oxygen (O₂), siloxanes, volatile organic compounds (VOCs), and/or particulates. Without being limiting, raw biogas may have a methane content between about 35% and 75% (e.g., average of about 60%) and a carbon dioxide content between about 15% and 65% (e.g., average of about 35%). The percentages used to quantify gas composition and/or a specific gas content, as used herein, are expressed as mol %, unless otherwise specified.

In one embodiment, the renewable methane is provided as partially purified biogas. The term “partial purification”, as used herein, refers to a process wherein biogas is treated to remove one or more non-methane components (e.g., CO₂, H₂S, H₂O, N₂, NH₃, H₂, CO, O₂, VOCs, and/or siloxanes) to produce a partially purified biogas, where the partially purified biogas fails to qualify as renewable natural gas (RNG) and/or will be subject to further purification. In one embodiment, the method includes upgrading raw or partially purified biogas provided (e.g., prior to hydrogen production).

In one embodiment, the renewable methane is provided as renewable natural gas (RNG). The term “renewable natural gas” or “RNG”, as used herein, refers to biogas (or another gas containing renewable methane) that has been upgraded to meet or exceed applicable pipeline quality standards and/or specifications, meet or exceed applicable quality specifications for vehicle use (e.g., CNG specifications), and/or a gas that is recognized and/or qualifies as RNG under applicable regulations. For example, RNG includes natural gas leaving a distribution system that has been assigned environmental attributes associated with a corresponding amount of renewable natural gas, upgraded from biogas, that was injected into the distribution system. Pipeline specifications include specifications required for the biogas for injection into pipeline. Pipeline quality standards or specifications may vary by region and/or country in terms of value and units. For example, pipelines standards may require a methane level that is greater than 95%. In addition, or alternatively, the pipeline standards may refer to the purity of the gas expressed as a heating value (e.g., MJ/m³ or in BTU/standard cubic foot). Pipeline standards may require, for example, that the heating value of RNG be greater than about 950 BTU/scf, greater than about 960 BTU/scf, or greater than about 967 BTU/scf. In the United States (US), RNG and CNG standards may vary across the country.

In one embodiment, the renewable methane is provided as compressed RNG (bio-CNG) or liquefied RNG (bio-LNG). In one embodiment, the renewable methane is provided as RNG withdrawn from a natural gas distribution system. For example, in one embodiment, the renewable methane is provided by withdrawing gas from a natural gas distribution system and reporting at least a portion of the withdrawn gas as dispensed RNG. In one embodiment, the renewable methane is provided by withdrawing gas from a natural gas distribution system, wherein the amount of gas withdrawn (e.g., in MJ) is associated with an equivalent amount of RNG injected into the natural gas distribution system. In one embodiment, the renewable methane is provided by injecting a quantity of RNG into a natural gas distribution system, and withdrawing an equivalent (or lower) amount of gas from the natural gas distribution system, where the withdrawn gas is recognized and/or qualifies as RNG under applicable regulations. The term “distribution system”, as used herein, refers to a single pipeline or interconnected network of pipelines (i.e., physically connected). Distribution systems are used to distribute a product (e.g., natural gas), often from its source to multiple users and/or destinations (e.g., businesses and households). A distribution system can include pipelines owned and/or operated by different entities and/or pipelines that cross state, provincial, and/or national borders, provided they are physically connected. One example of a distribution system is the US natural gas grid, which includes interstate pipelines, intrastate pipelines, and/or pipelines owned by local distribution companies.

In one embodiment, providing the renewable methane includes transporting the renewable methane (e.g., raw biogas, partially purified biogas, or RNG) to the hydrogen production unit(s) and/or fuel production facility in a vessel and/or by pipeline. In one embodiment, where the renewable methane is transported to the hydrogen production unit(s) and/or fuel production facility as RNG, the method includes transporting RNG to the hydrogen production unit(s) and/or fuel production facility as a fungible batch using a natural gas distribution system. When RNG is provided as a fungible batch in a distribution system, a quantity of RNG is injected into the distribution system, where it can comingle with non-renewable methane (derived from fossil sources), and an equivalent quantity (e.g., MJ) of gas is withdrawn at another location. Since the transfer or allocation of the environmental attributes of the RNG injected into the distribution system to gas withdrawn at a different location is typically recognized, the withdrawn gas is recognized as RNG and/or qualifies as RNG under applicable regulations (e.g., even though the withdrawn gas may not contain actual molecules from the original biomass and/or contains methane from fossil sources). Such transfer may be made on a displacement basis, where transactions within the distribution system involve a matching and balancing of inputs and outputs. Typically, the direction of the physical flow of gas is not considered. In one embodiment, the balancing of inputs and/or outputs includes monitoring the energy content and/or energy delivered. The term “energy content”, as used herein, refers to the energy density, and more specifically to the amount of energy contained within a volume of gas (e.g., measured in units of BTU/scf or MJ/m³). Heating value is one example of an energy content measurement. The term “energy delivered”, as used herein, is a measure of the amount of energy delivered to or from the distribution system in a particular time period, or series of time periods (e.g., discrete increments of time), such as, without limitation, hourly, daily, weekly, monthly, quarterly, or yearly intervals. The energy delivered may be obtained after determining values representing the energy content and flow (e.g., volume) for a particular time period. In particular, the energy delivered may be obtained from the product of these two values, multiplied by the time according to the following: Energy delivered (BTU)=Σ ((energy content (BTU/cubic foot)*volume of flow (cubic feet/min))*number of minutes. In one embodiment, the energy delivered is provided by a meter. The term “batch”, as used herein, refers to a certain amount of the gas (e.g., measured using volume, mass, and/or energy delivered) and does not imply or exclude an interruption in the production and/or delivery.

In one embodiment, the method includes obtaining, generating, or receiving documentation (e.g., electronic or paper) that evidences that a gas withdrawn from a natural gas distribution system is recognized as and/or qualifies as RNG under applicable regulations. In general, such documentation can vary according to the applicable regulatory agency. In one embodiment, this documentation includes reports indicating a) a quantity of renewable natural gas was dispensed from a distribution system, b) a quantity of RNG was injected into the distribution system, c) proof of the origin, d) evidence that the environmental attributes of the injected RNG were transferred, or e) any combination of a-d. In one embodiment, the documentation includes a) one or more attestations, b) proof of sustainability, c) verification statements, d) certificates, e) guarantees of origin, f) chain of custody evidence, and/or g) approved fuel pathways.

In one embodiment, the method includes obtaining, generating, or receiving documentation issued by a regulatory agency or by a third party (e.g., an entrusted and/or accredited individual or body. For example, some regulatory agencies may entrust and/or accredit one or more verification, validation, and/or certification bodies to confirm that that specific fuels are sourced at least in part from renewable material and/or that at least a portion of the fuel qualifies as a renewable fuel under the applicable regulations. Verification refers to a systematic, independent, and documented process for evaluating reported data against regulation requirements. An accredited verification body may provide validation or verification statements and/or validation or verification services. A certification body may provide certificates (e.g., green gas certificates or biogas certificates). For example, the ISCC-EU is a certification system to demonstrate compliance with the legal sustainability requirements specified in the RED of the European Commission. Verification of compliance with the ISCC requirements, as well as issuance of ISCC certificates, can be performed by recognized third-party certification bodies cooperating with ISCC.

In one embodiment, the method includes providing renewable methane for use in producing one or more fuels from a fuel production process that includes hydrogen production, wherein providing the renewable methane includes withdrawing RNG from a natural gas distribution system and/or allocating RNG withdrawn from a natural gas distribution system to selected hydrogen production units. The term “renewable methane”, as used herein, refers to methane in biogas (raw or partially purified), methane in RNG, and/or methane that is recognized as and/or qualifies as renewable under applicable regulations. Establishing that a gas is recognized as and/or qualifies as renewable methane/RNG (e.g., originates from renewable sources) under applicable regulations can depend on whether the gas is transported by truck or by pipeline and the practices and requirements of the applicable regulatory agency, where such practices may include, for example, the use of chain of custody accounting methods such as identity preservation, book-and-claim, and a mass balance system.

In one embodiment, the renewable methane is provided in a feedstock for the hydrogen production and/or the fuel production process. The term “feedstock”, as used herein, refers to material entering a production process that contributes atoms to any product of the production process or is deemed to contribute atoms to any product (e.g., a fuel product) of the production process. In one embodiment, the feedstock contains raw biogas, partially purified biogas, or RNG. In one embodiment, the feedstock is natural gas withdrawn from a natural gas distribution system, a fraction of which is recognized as and/or qualifies as RNG under applicable regulations.

In one embodiment, a feedstock for the fuel production process is provided by withdrawing a gas from a natural gas distribution system, wherein a fraction of the withdrawn gas is recognized as and/or qualifies as RNG under applicable regulations.

### Hydrogen Production

In general, the renewable methane is provided for use in a fuel production process that uses hydrogen produced from multiple hydrogen production units. The term “hydrogen production unit”, as used herein, refers to a system or combination of systems primarily used for production of hydrogen from a methane containing gas (e.g., natural gas).

In one embodiment, the multiple hydrogen production units include one or more on-site hydrogen production units and/or one or more off-site hydrogen production units. The term “off-site hydrogen production unit”, as used herein, refers to a hydrogen production unit that has a separate address from the fuel production facility and/or that is owned and/or operated by another entity (i.e., other than the fuel producer). The term “on-site hydrogen production unit”, as used herein, refers to a hydrogen production unit that shares the same address/geographic location as the fuel production facility and/or is owned and/or operated by the same entity (i.e., the fuel producer). Hydrogen produced at an off-site hydrogen production unit can be transported to the fuel production facility via a hydrogen pipeline (e.g., a hydrogen distribution system that is fed by multiple off-site hydrogen production units and that can connect to the hydrogen pipe system at the fuel production facility).

In general, each of the multiple hydrogen production units includes a methane reformer and a hydrogen purification system, where the methane reformer and/or hydrogen purification system is based on any suitable technology. In one embodiment, each methane reformer includes one or more reactors configured to promote a steam methane reforming (SMR), autothermal reforming (ATR), partial oxidation (PDX), and/or dry methane reforming (DMR) reaction.

In one embodiment, one or more of the hydrogen production units includes a steam methane reformer. A steam methane reformer includes one or more reactors configured to support the following SMR reaction:

CH₄+H₂O+heat→CO+3H₂ (1)

The carbon monoxide in the syngas produced by the SMR may be reacted with water in a water gas shift (WGS) reaction to form carbon dioxide and more hydrogen, as follows:

CO+H₂O→CO₂+H₂+small amount of heat (2)

The heat required for the catalytic reforming of Eq. (1) may be provided by burning a fuel in the combustion chamber of the steam methane reformer (e.g., the combustion chamber may surround the reformer tubes in which the SMR reaction is conducted). Without being limiting, the catalyst may be nickel-based. Optionally, the catalyst is supported on a support of suitable material (e.g., alumina, etc.) Optionally, promoters (e.g., MgO) are added. Without being limiting, conventional steam methane reformers may operate at pressures between 200 psig (1.38 MPa) and 600 psig (4.14 MPa) and temperatures between about 450 to 1000° C.

In one embodiment, one or more of the hydrogen production units includes a steam methane reformer and one or more water gas shift (WGS) reactors, which may also be referred to as shift converters. For example, in the SMR reaction discussed with regard to Eq. 1, the SMR catalyst may be active with respect to the WGS reaction in Eq. 2. For example, the gas leaving the steam reformer may be in equilibrium with respect to the WGS reaction. However, syngas leaving the steam methane reformer typically contains a significant amount of carbon monoxide that can be converted in the WGS reaction. Since the WGS reaction is exothermic, cooling of the syngas over a selected catalyst may promote the WGS reaction, and thus may increase the H₂ content of the syngas while decreasing the CO content. Accordingly, it may be advantageous to provide one or more WGS reactors (i.e., shift reactors) downstream of the methane reforming. In general, shift reactors may use any suitable type of shift technology (e.g., high temperature shift conversion, medium temperature shift conversion, low temperature shift conversion, sour gas shift conversion, or isothermal shift). For example, WGS reactions may be conducted at temperatures between 320-450° C. (high temperature) and/or between 200-250° C. (low temperature). Without being limiting, high temperature thermal shift may be conducted with an iron oxide catalyst (e.g., supported by chromium oxide), whereas low temperature thermal shift may be conducted with a Cu/ZnO mixed catalyst. Optionally, a promoter is added. In general, there may be one or more stages of WGS to enhance the hydrogen concentration in the syngas. For example, the WGS may be conducted in a high temperature WGS reactor (e.g., 350° C.) followed by a low temperature WGS reactor (e.g., 200° C.). Without being limiting, the syngas from the SMR and/or WGS reactor (e.g., which may be at about 210-220° C.) can be cooled (e.g., to 35-40° C.), and the condensate separated, prior to hydrogen purification.

In one embodiment, one or more of the hydrogen production units includes a steam methane reformer and a hydrogen purification system. Hydrogen purification processes typically remove carbon dioxide, carbon monoxide, methane and/or any other impurities from the syngas to provide a stream enriched in hydrogen (i.e., containing at least 80% hydrogen). Without being limiting, some examples of suitable hydrogen purification processes for the hydrogen purification include: a) absorption, b) adsorption, c) membrane separation, d) cryogenic separation, and e) methanation.

Absorption processes that remove carbon dioxide may include scrubbing with a weak base (e.g., hot potassium carbonate) or an amine (e.g., ethanolamine). For example, carbon dioxide may be captured using a monoethanolamine (MEA) unit or a methyl-diethanolamine (MDEA) unit. A MEA unit may include one or more absorption columns containing an aqueous solution of MEA at about 30 wt %. The outlet liquid stream of solvent may be treated to regenerate the MEA and separate carbon dioxide.

Adsorption processes may use an adsorbent bed (e.g., molecular sieves, activated carbon, active alumina, or silica gel) to remove impurities such as methane, carbon dioxide, carbon monoxide, nitrogen, and/or water from the syngas. More specifically, these impurities may be preferentially adsorbed over hydrogen, yielding a relatively pure hydrogen stream. Moreover, since the impurities may be adsorbed at higher partial pressures and desorbed at lower partial pressures, the adsorption beds may be regenerated using pressure. Such systems/processes are typically referred to as pressure swing adsorption (PSA) systems/processes. In general, PSA systems may be the most commonly used hydrogen purification processes used in hydrogen production units. Some adsorption beds may be regenerated with temperature.

Membrane separation is based on different molecules having varying permeability through a membrane. More specifically, some molecules, referred to as the permeant(s) or permeate, diffuse across the membrane (e.g., to the permeate side). Other molecules do not pass through the membrane and stay on the retentate side. The driving force behind this process is a difference in partial pressure, wherein the diffusing molecules move from an area of high concentration to an area of low concentration. For hydrogen purification, the permeable gas typically is hydrogen. While hydrogen separation through a membrane may have a relatively high recovery rate, this may come at the expense of reduced purity.

Cryogenic separation is based on the fact that different gases may have distinct boiling/sublimation points. Cryogenic separation processes may involve cooling the product gas down to temperatures where the impurities condense or sublimate and can be separated as a liquid or a solid fraction, while the hydrogen accumulates in the gas phase. For example, cryogenic separations may use temperatures below −10° C. or below −50° C.

Methanation is a catalytic process conducted to convert the residual carbon monoxide and/or carbon dioxide in the syngas to methane, according to the following.

CO+3H₂→CH₄+H₂O (3)

Since the methanation reaction consumes hydrogen, it can be advantageous to provide a carbon dioxide removal step prior to the methanation step.

In one embodiment, one or more of the hydrogen production units includes a steam methane reformer and a hydrogen purification system that removes carbon dioxide removal using wet scrubbing (e.g., using amine absorption and regeneration), and converts any carbon monoxide and/or carbon dioxide remaining after the scrubbing process to methane in a methanation reaction. This approach may provide a product stream that is about 95%-97% hydrogen. It may also provide a relatively pure carbon dioxide stream (e.g., 99%).

In one embodiment, one or more of the hydrogen production units includes a steam methane reformer and a hydrogen purification system that removes carbon oxides using PSA. This approach may provide a product stream that is about 99.9% hydrogen. In general, PSA is the most common method of hydrogen purification following WGS, likely due to the high purity levels and overall energy efficiency (e.g., relative to wet scrubbing). The purge gas from the PSA, which may contain hydrogen, carbon monoxide, and unconverted methane, may be fed back to the methane reformer (e.g., as fuel).

In one embodiment, one or more of the hydrogen production units includes a steam methane reformer, a hydrogen purification system, and one or more additional systems for hydrogen production. For example, conventional hydrogen production units may include a feedstock purification stage, a pre-reforming stage, and/or one or more boilers to generate steam. A purification system may be provided to remove sulfur, chloride, olefin, and/or other compounds from natural gas, which may be detrimental to downstream reforming catalysts (e.g., may include a desulfurization unit). A pre-reforming system may allow a higher inlet feed temperature with minimal risk of carbon deposition. For hydrogen production wherein renewable hydrogen is produced from a raw biogas or partially purified biogas feedstock, it may be advantageous for the hydrogen production unit to include a biogas cleaning and/or biogas upgrading system.

In one embodiment, each of multiple hydrogen production units are connected to a hydrogen pipe system that conveys hydrogen produced at the multiple hydrogen production units and/or as a by-product (e.g., from a reforming unit). For example, the pipe system may include a first pipe that provides hydrogen produced only at a first hydrogen production unit to one or more hydroprocessing units, and/or a second pipe that conveys hydrogen provided from multiple hydrogen sources.

In one embodiment, the method includes providing renewable methane to one or more of the hydrogen production units. In one embodiment, the method includes providing one or more of the hydrogen production units with RNG withdrawn from a natural gas distribution system. In one embodiment, the method includes providing one or more of the hydrogen production units with a natural gas feedstock, where the natural gas is withdrawn from a natural gas distribution system and includes a portion that is recognized as and/or qualifies as RNG under applicable regulations. The term “natural gas”, as used herein, refers to mixture of hydrocarbon compounds that is gaseous at standard temperatures and pressures, where the primary component is methane. In general, it is common for the methane reformers in a hydrogen production unit to be able to convert any of the hydrocarbons present in natural gas to syngas (i.e., not just the methane).

When renewable methane is provided in a feedstock supplying one or more hydrogen production units, the process can produce renewable hydrogen. The term “renewable hydrogen”, as used herein, refers to hydrogen produced using renewable methane and/or RNG as described herein or to hydrogen deemed under applicable regulations to be produced using renewable methane. For example, the term “renewable hydrogen”, as used herein, includes hydrogen produced using methane derived from biomass (and not fossil sources) and/or a gas withdrawn from a distribution system that is recognized as and/or qualifies as RNG under applicable regulations.

In general, when renewable methane is provided in a feedstock supplying one or more hydrogen production units that produce hydrogen for, or for part of, a fuel production process, the fuel production process can produce one or more fuels containing renewable content. In some embodiments, the renewable methane is provided as both a feedstock and a fuel for the methane reforming. For example, consider the case where a portion of the renewable methane is allocated to the combustion zone of an SMR reactor. Since combusting renewable methane simply returns to the atmosphere carbon that was recently fixed by photosynthesis, and thus is considered relatively benign, this can reduce greenhouse gas emissions from the SMR furnace (e.g., compared to using fossil-based methane). Furthermore, since the renewable methane may be provided as raw biogas or partially purified biogas, process costs can be reduced. For example, if the hydrogen production process includes upgrading biogas to RNG, which is a feedstock for SMR, then using a portion of the raw biogas or partially purified biogas as fuel for the SMR, means that a smaller volume of biogas needs to be fully upgraded, thereby reducing costs. In one embodiment, a tail gas (e.g., methane slip) from the biogas upgrading is used, at least in part, to fuel the SMR.

While it may be advantageous to sacrifice some renewable methane for fuel in order to improve the greenhouse gas balance of the hydrogen production process and/or fuel production process, this reduces the yield of renewable hydrogen and/or the yield of renewable content of the fuel(s) produced. Accordingly, there may be a compromise between increasing the yield of renewable hydrogen/renewable content and decreasing the lifecycle GHG emissions of the fuel, for a given quantity of renewable methane.

The yield of renewable hydrogen can be calculated based on energy and expressed as an energy yield. The term “energy yield”, as used herein with regard to a specific fuel produced by a process, refers to the energy in the fuel produced by the process (e.g., MJ) divided by the energy in the feedstock(s) fed into the process (e.g., in MJ), for a given time period. The energy in the fuel or each feedstock (in MJ) may, for example, be determined from its mass flow rate (kg/hr) multiplied by its heating value (MJ/kg) and the time period (hr). The energy yield for a fuel may be expressed as a percentage. For a hydrogen production process, the feedstock is typically natural gas and the product is hydrogen. In an oil refinery, some non-limiting examples of feedstock can include natural gas, crude oil, hydrogen, and/or unfinished oils (e.g., other hydrocarbons), while some non-limiting examples of products include naphtha, diesel, gasoline, and/or kerosene.

When producing renewable hydrogen and/or fuel(s) having renewable content (e.g., gasoline, diesel, kerosene, etc.), the feedstock can include both renewable methane and non-renewable methane (e.g., obtained and/or derived from fossil resources). Accordingly, determining the energy yield of renewable hydrogen and/or the renewable content of any fuel produced by the process can include determining what fraction of the methane containing feedstock (e.g., natural gas) is renewable. For example, consider the following example, wherein an SMR-based hydrogen production unit is configured to produce about 120 MJ/hr of hydrogen for every 100 MJ/hr of natural gas provided as feedstock. In this case, the hydrogen production unit has an energy yield for hydrogen of about 1.2 or 120% (e.g., the calculations do not account for steam and/or the natural gas used to fuel the SMR). Now consider the case, where 50 MJ/hr of RNG is available for use with this hydrogen production unit. If the full 50 MJ/hr of RNG is used as feedstock for the SMR (i.e., together with 50 MJ/hr of non-renewable natural gas), then the process produces 60 MJ/hr of renewable hydrogen and 60 MJ/hr of non-renewable hydrogen. In this case, the energy yield of renewable hydrogen can be determined by multiplying the energy yield for total hydrogen production (i.e., 1.2) by the fraction of the feedstock that is renewable (i.e., 0.5).

In order to better appreciate the compromise between the yield of renewable hydrogen and the greenhouse gas emissions balance, for a given quantity of the renewable methane, consider the comparative example wherein, of the 50 MJ/hr of RNG available for use with the hydrogen production unit, 40 MJ/hr are used as feedstock for the SMR and 10 MJ/hr are used to fuel the SMR. In this case, the feedstock for the SMR will include 40 MJ/hr of RNG and 60 MJ/hr of non-renewable methane, such that the process only produces 48 MJ/hr of renewable hydrogen. Accordingly, the compromise may include choosing between providing 60 MJ/hr of renewable hydrogen associated with some carbon intensity, or about 48 MJ/hr of renewable hydrogen associated with a lower carbon intensity (e.g., higher greenhouse gas reduction).

In one embodiment, all of the renewable methane is provided in the feedstock (i.e., none is used to fuel the methane reformer). In this embodiment, the yield of renewable hydrogen, and thus the amount of renewable hydrogen (e.g., in MJ/hr) that can be incorporated into the one or more fuels produced by the fuel production process can be maximized.

In one embodiment, a first amount of the renewable methane (e.g., in MJ/hr) is allocated to feedstock for the methane reformer, while a second amount of the renewable methane (e.g., in MJ/hr) is allocated as fuel for producing process heat for the methane reformer. The term “allocating”, as used herein in respect of a particular element, refers to designating the element for a specific purpose. For example, an amount of renewable methane and/or RNG can be allocated as feedstock for one or more hydrogen production units. In one embodiment, allocating renewable methane and/or RNG as feedstock to one or more selected hydrogen production units includes assigning the environmental attributes of the renewable methane and/or RNG provided to an equivalent amount of methane and/or natural gas, respectively, used as feedstock for the selected hydrogen production units. In one embodiment, allocating renewable methane and/or RNG as feedstock for one or more hydrogen production units includes physically directing a gas containing the renewable methane and/or RNG to the selected hydrogen production units. The term “environmental attributes”, as used herein with regard to a specific material (e.g., renewable methane or RNG), refers to any and all attributes related to the material, including all rights, credits, benefits, or payments associated with the renewable nature of the material and/or the reduction in or avoidance of fossil fuel consumption or reduction in lifecycle greenhouse gas emissions associated with the use of the material. Some non-limiting examples of environmental attributes include verified emission reductions, voluntary emission reductions, offsets, allowances, credits, avoided compliance costs, emission rights and authorizations, certificates, voluntary carbon units, under any law or regulation, or any emission reduction registry, trading system, or reporting or reduction program for greenhouse gas emissions that is established, certified, maintained, or recognized by any international, governmental, or nongovernmental agency.

In one embodiment, the ratio of the amount of renewable methane provided in feedstock for the methane reformer (i.e., in MJ/hr) to the amount of renewable methane provided for producing process heat for the methane reformer (i.e., in MJ/hr), which is herein referred to as the “feedstock:fuel ratio”, is selected in dependence upon the desired renewable content and/or carbon intensity of the fuel(s) produced. The feedstock:fuel ratio can be determined for each hydrogen production unit and/or for all hydrogen production for the fuel production process.

In one embodiment, the feedstock:fuel ratio(s) is selected to provide the fuel and/or renewable content with a lifecycle greenhouse gas reduction that is selected to keep the carbon intensity of one or more fuels produced, and/or of the renewable content, at or below a target value. In one embodiment, the feedstock:fuel ratio(s) is selected to provide the fuel and/or renewable content with a lifecycle greenhouse gas reduction that is greater than a predetermined threshold. In one embodiment, the target value and/or predetermined threshold is set by a regulatory agency (e.g., the United States Environmental Protection Agency or “EPA” or the European Commission). In one embodiment, the feedstock:fuel ratio(s) is selected to provide the fuel and/or renewable content with a lifecycle greenhouse gas reduction that is at least 50% or at least 60% of the average emissions baseline of gasoline or diesel as determined by the regulatory agency (e.g., the 2005 gasoline baseline or the 2005 diesel baseline as determined by the EPA, which correspond to 96.3 kgCO₂e/MMBtu and 95 kgCO₂e/MMBtu, respectively). For example, in one embodiment, the fuel produced is gasoline and the feedstock:fuel ratio(s) is selected such that the lifecycle greenhouse gas emissions are at least 50% lower than a gasoline baseline as measured by EPA methodology. In one embodiment, the fuel produced is gasoline and the feedstock:fuel ratio(s) is selected such that the lifecycle greenhouse gas emissions are at least 60% lower than a gasoline baseline as measured by EPA methodology.

In one embodiment, the feedstock:fuel ratio, for one or more hydrogen production units and/or for total hydrogen production is 1:1, 2:1, 3:1, 4:1, 5:1, 6:1, 7:1, 8:1, or 9:1. In one embodiment, at least 10% and no more than 50% of the renewable methane is provided for process heat (i.e., by energy). In one embodiment, the feedstock:fuel ratio(s) is selected to provide the fuel and/or fuel production process with a predetermined greenhouse gas emissions reduction. For example, if the fuel produced has a certain carbon intensity or lifecycle greenhouse gas emission value, which does not meet some target value, then the feedstock:fuel ratio for one or more hydrogen production units and/or for total hydrogen production can be adjusted in order to meet the target value.

In accordance with one embodiment of the invention, the compromise between increasing the yield of renewable hydrogen (and thus the yield of renewable content) and reducing the carbon intensity of the fuel(s) and/or renewable content, is lessened or negated by allocating an amount of renewable methane and/or RNG (e.g., in MJ/hr) to one or more hydrogen production units selected over other hydrogen production units also providing hydrogen for the fuel production process, where the one or more selected hydrogen production units are selected to increase the yield of renewable hydrogen and/or reduce the carbon intensity of one or more fuel(s).

In one embodiment, an amount of renewable methane and/or RNG provided for renewable hydrogen production (e.g., in MJ/hr) is allocated to one or more hydrogen production units selected to reduce the carbon intensity of the fuel(s) having renewable content and/or the renewable content (e.g., for a given amount of renewable methane). In one embodiment, an amount of renewable methane and/or RNG provided for renewable hydrogen production (e.g., in MJ/hr) is allocated to one or more hydrogen production units selected to increase the yield of renewable content in the fuel produced (e.g., for a given amount of renewable methane).

With regard to allocating the renewable methane and/or RNG to one or more hydrogen production units selected to reduce the carbon intensity of the fuel(s) having renewable content and/or of the renewable content, it has now been recognized that, in spite of the relatively high efficiency of off-site hydrogen production units (e.g., which typically use newer technologies and/or exploit economies of scale), the carbon intensity of fuel(s) having renewable content and/or the renewable content produced using a feedstock containing renewable methane can be lower when the renewable methane is directed and/or allocated to on-site hydrogen production units (i.e., rather than off-site). For example, the carbon intensity of the fuel(s) having renewable content and/or the renewable content can be lower when the GHG emissions intensity corresponds to the average of an oil refinery rather than the hydrogen production (e.g., as accepted under some regulations).

In one embodiment, the method includes preferentially allocating the renewable methane and/or RNG to on-site hydrogen production unit(s). For example, in one embodiment, at least 51%, at least 52%, at least 53%, at least 55%, at least 60%, at least 65%, at least 70%, at least 75%, least 80%, at least 85%, at least 90%, or at least 95% of the renewable methane and/or RNG in the feedstock of the fuel production process is directed to one or more on-site hydrogen production units rather than to an off-site hydrogen production unit(s). In one embodiment, 100% of the renewable methane and/or RNG provided in the feedstock of the fuel production process is provided to on-site hydrogen production units. In one embodiment, the method includes allocating the renewable methane and/or RNG such that substantially all of renewable methane provided for the fuel production process is only directed and/or allocated to on-site hydrogen production units.

In one embodiment, the method includes allocating the renewable methane and/or RNG to one or more selected hydrogen production units such that the renewable content of one or more fuels produced by the fuel production process can be calculated assuming that the feedstock for each of the selected hydrogen production units (e.g., natural gas withdrawn from a distribution system) has a renewable fraction that is greater than a renewable fraction of the feedstock for one or more other hydrogen production units that also provide hydrogen for the fuel production process.

The “renewable fraction” of feedstock for one or more hydrogen production units is calculated as:

$$\frac{\begin{matrix}\begin{matrix}energy of the feedstock ( MJ ) \\ that is recognized as and / or\end{matrix} \\ qualifed as renewable\end{matrix}}{total energy of feedstock ( MJ )} \qquad ( 4 )$$

In general, the renewable fraction will be calculated over a given time period (e.g., hour, 3 months). For example, if a given hydrogen production unit receives a natural gas feedstock at a rate of 100 MJ/hour, 50 MJ/hr of which is recognized as and/or qualifies as RNG under applicable regulations, then the renewable fraction of the feedstock is 0.5. In another example, if one or more hydrogen production units use “X” MJ of natural gas as feedstock to produce hydrogen over a 3 month reporting period, and 0.25*X MJ of renewable natural gas is purchased and allocated as feedstock for these hydrogen production units within the same reporting period, then the renewable fraction of the feedstock for these hydrogen production units is 0.25.

If all of the hydrogen production units connected to the pipe system at the fuel production facility (e.g., including on-site and off-site hydrogen production units) collectively receive “N” MJ/hr of natural gas as feedstock for hydrogen production for the fuel production facility, of which “M” MJ/hr is recognized as and/or qualifies as RNG under applicable regulations, then the renewable fraction of feedstock for all hydrogen production is R, where R=M/N. Allocating at least a portion of the renewable methane can cause the renewable fraction of feedstock to one or more of the hydrogen production units to differ from R.

In one embodiment, the method includes allocating at least a portion of the renewable methane and/or RNG to an on-site hydrogen production unit such that the renewable fraction of feedstock for the on-site hydrogen production unit is higher than the renewable fraction of feedstock for all hydrogen production for the fuel production process. In one embodiment, the method includes allocating at least a portion of the renewable methane and/or RNG to an on-site hydrogen production unit such that the renewable fraction of feedstock for the on-site hydrogen production unit is higher than the renewable fraction of feedstock for an off-site hydrogen production unit also connected to the pipe system.

Advantageously, allocating the renewable methane and/or RNG to one or more on-site hydrogen production units can decrease (e.g., minimize) the carbon intensity of the fuel(s) produced for a given quantity of renewable methane and/or RNG provided. Decreasing (e.g., minimizing) the carbon intensity of the fuel(s) produced can be particularly important because in some cases, without allocating the renewable methane and without sacrificing a portion of the renewable methane to produce process heat for the methane reformer, the carbon intensity of the fuel(s) having renewable content and/or the renewable content can be too high for the fuel(s) having renewable content and/or the renewable content to qualify as renewable under applicable regulations.

Further advantageously, this decrease in carbon intensity for the fuel(s) produced can be achieved without having to sacrifice a portion of the renewable methane to provide process heat for the methane reforming. More specifically, allocating the renewable methane to one or more on-site hydrogen production units (e.g., selected over off-site hydrogen production units), the carbon intensity of the fuel can be reduced without having to divert a portion of the renewable methane as fuel, thereby reducing or avoiding renewable hydrogen yield loss.

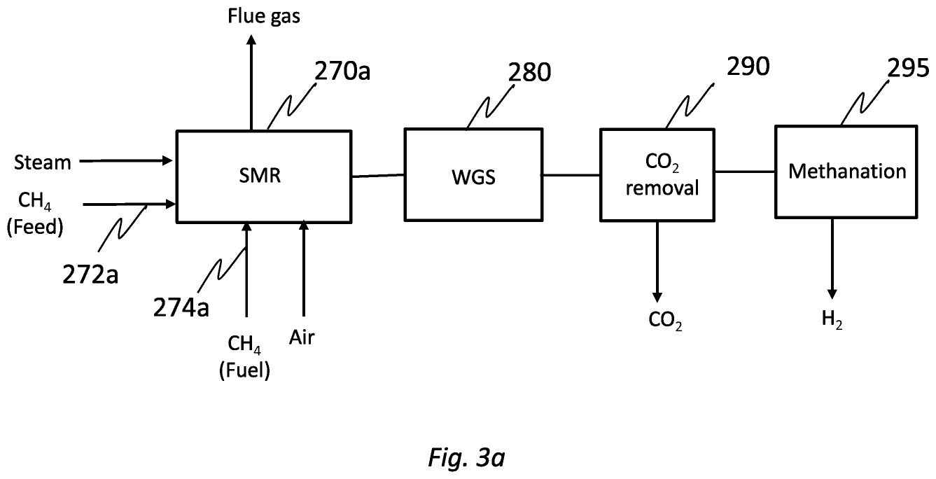

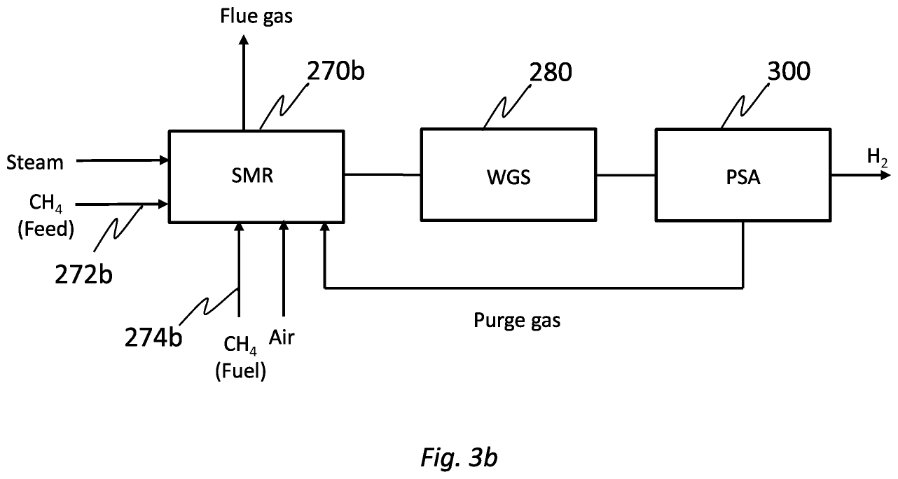

In general, the energy yield for hydrogen (including renewable hydrogen) for a given hydrogen production unit can be dependent on the technology used for methane reforming and/or hydrogen purification. Most of the hydrogen produced from methane is made via SMR. Conventionally, SMR-based hydrogen production units remove carbon dioxide from the syngas using a solvent-based process (e.g., a wet removal process). More recently, SMR-based hydrogen production units use PSA systems. Examples of an older style and a newer style hydrogen production unit are illustrated in FIG. 3a and FIG. 3b, respectively.

FIG. 3a illustrates a schematic embodiment of an older style hydrogen production unit, where hydrogen purification is accomplished using wet scrubbing (e.g., amine absorption and regeneration cycle). In this embodiment, a stream of preheated natural gas 272a is desulfurized (not shown) and fed, along with steam, into the reactor tubes of the SMR 270a, which contain the reforming catalyst. Streams of natural gas 274a and combustion air are fed into the SMR burners, which fire into the reactor section of the SMR to provide the heat required for the endothermic reaction. The syngas produced in the SMR is fed to a WGS 280 to produce a shifted gas. In this case, the WGS 280 may use a high temperature WGS reactor followed by a low temperature WGS reactor. Cooled shifted gas is contacted with an amine solvent (e.g., MEA or MDEA) in the absorption system 290 to capture the CO₂. Optionally, the stream enriched in hydrogen may be fed into a methanator 295 in order to convert any remaining carbon monoxide and/or carbon dioxide to methane.

FIG. 3b illustrates a schematic embodiment of a newer style hydrogen production unit, where hydrogen purification is accomplished using PSA. In this embodiment, a stream of preheated natural gas 272b is desulfurized (not shown) and fed, along with steam, into the reactor tubes of the SMR 270b, which contain the reforming catalyst. Streams of natural gas 274b and combustion air are fed into the SMR burners, which fire into the reactor section of the SMR to provide the heat required for the endothermic reaction. The syngas produced in the SMR is fed to a WGS 280 to produce a shifted gas. In this case, the WGS 280 may use a high temperature WGS reactor. The shifted gas is cooled and is purified in the PSA unit 300, which produces a stream of hydrogen and a purge stream. The purge stream, which may contain unconverted CH₄, H₂, CO₂, and/or CO, is fed back to the SMR, where it is used to provide process heat for the SMR (e.g., fuel the SMR burners). More specifically, the purge stream is combusted together with the stream of natural gas 274b. Since the purge stream contains some fuel (e.g., CH₄, CO, and/or H₂), less fuel natural gas 274b is required.

In general, the newer style hydrogen production unit (e.g., FIG. 3b) is understood to be more energy efficient (e.g., requires less natural gas to produce the same amount of hydrogen) and thus typically is associated with a more favourable greenhouse gas balance. However, as described herein, the older style hydrogen production unit can be preferable for producing hydrogen from a feedstock containing renewable methane.

For example, consider a hydrogen production unit configured to use an off gas (e.g., a purge gas from SMR) of the hydrogen production process to produce heat for the reforming process (e.g., recycled to the SMR burners). In this case, the energy efficiency is higher than for an analogous case wherein the heat for reforming is produced primarily from natural gas withdrawn from a commercial distribution system. This is because less natural gas from the distribution system is typically required. Higher energy efficiency is generally considered advantageous in terms of producing a renewable fuel(s). However, it has now been recognized that hydrogen production units having a reforming unit that is not configured to combust an off-gas to produce heat for the reforming (i.e., an older style hydrogen production unit) can have a higher energy yield (for hydrogen) than a newer style hydrogen production unit, and that this is advantageous for fuel production processes using a feedstock containing renewable methane. For example, older style hydrogen production units often have an energy yield for hydrogen in the range of about 1.2 to about 1.3, whereas newer style hydrogen production units often have an energy yield for hydrogen in the range of about 0.90 to about 1.1 (e.g., 0.95). Accordingly, although a newer style hydrogen production unit may be associated with higher energy efficiency, the inventor has discovered that it produces less renewable hydrogen from a given quantity of renewable methane (by energy). Accordingly, more renewable hydrogen may be obtained from the older style production unit for a given amount of renewable methane feedstock.

In addition, although the newer style SMR is generally associated with a higher energy efficiency, and thus a lower GHG emissions, the GHG emissions of an older style hydrogen production unit can be reduced when carbon capture and storage (CCS) is employed. In general, SMR can be a large contributor to carbon dioxide emissions. Without being limiting, about 60% of the carbon dioxide produced may be generated in the reforming zones of the SMR and/or WGS reactors, while about 40% may be generated in the combustion zone of SMR reactor (i.e., from the SMR furnace). In the embodiment illustrated in FIG. 3a, carbon dioxide produced in reforming zones is captured in the amine scrubbing, while carbon dioxide produced in the combustion zone may be emitted in the flue gas. In the embodiment illustrated in FIG. 3b, carbon dioxide produced in the reforming zones is recycled back to the combustion zone (i.e., as the purge gas), such that the flue gas contains carbon dioxide produced in both the reforming and combustion zones. Since capturing carbon dioxide from the wet scrubbing may be technically and/or economically more feasible relative to capturing carbon dioxide from the flue gas, the older style hydrogen production unit can be more suitable for CCS approaches of reducing lifecycle GHG emissions of the process. Various forms of CCS have been proposed for storage of carbon dioxide, including geologic sequestration, which involves injecting carbon dioxide directly into underground geological formations.

In one embodiment, the method includes preferentially allocating the renewable methane and/or RNG to one or more older style hydrogen production units. For example, in one embodiment, at least 51%, at least 52%, at least 53%, at least 55%, at least 60%, at least 65%, at least 70%, at least 75%, at least 80%, at least 85%, or at least 90% of the renewable methane (by energy) is directed to one or more older style hydrogen production units (e.g., rather than to newer style hydrogen production unit(s)). In one embodiment, 100% of the renewable methane and/or RNG is provided to older style hydrogen production units. In one embodiment, 100% of the renewable methane and/or RNG is provided to a single older style hydrogen production unit.

In one embodiment, the method includes allocating at least a portion of the renewable methane and/or RNG such that the renewable fraction of the feedstock for an older style hydrogen production unit is higher the renewable fraction of the feedstocks used for all hydrogen production for the fuel production process (i.e., where the feedstock is natural gas). In one embodiment, the method includes allocating at least a portion of the renewable methane and/or RNG such that the renewable fraction of the feedstock for an older hydrogen production unit is higher than the renewable fraction of the feedstock for a newer style hydrogen production unit also connected to the pipe system.

In one embodiment, the method includes allocating at least a portion of the renewable methane and/or RNG such that a renewable fraction of the feedstock for a first hydrogen production unit is higher than the renewable fraction of the feedstock for a second hydrogen production unit, where a first fuel for producing process heat for the reforming in the first hydrogen production unit contains less process gas (e.g., recycled purge gas) in energy units (e.g., MJ/hr) than a second fuel for producing process heat for the reforming in the second hydrogen production unit. In one embodiment, the first fuel contains not more than 5%, not more than 10%, not more than 15%, or not more than 20% of its energy from process gas (e.g., recycled purge gas).

In one embodiment, the method includes allocating the renewable methane and/or RNG to one or more hydrogen production units that use a hydrogen purification unit based on an absorption process, and includes sequestering carbon dioxide removed from the syngas and/or shifted gas (e.g., injecting into oil or gas fields to assist oil or gas recovery, and/or used as a feedstock for making chemicals, fuels, and/or materials).

In one embodiment, the method includes allocating the renewable methane and/or RNG to one or more selected hydrogen production units, where each selected hydrogen production unit (a) is an older style hydrogen production unit, (b) is free of a pressure swing adsorption system, (c) has an absorption based hydrogen purification system, (d) has a solvent-based hydrogen purification system, (e) does not produce heat for the methane reformer from a gas produced by hydrogen purification (e.g., purge gas from a PSA or methane slip from a membrane system), (0 produces heat for the reforming primarily from gas from a natural gas distribution system (e.g., at least 90%) (g) has an energy yield for hydrogen that is greater than 1 or is at least 1.1 or 1.2, and/or (h) is selected in dependence upon its energy yield for hydrogen relative to other hydrogen production units. For example, in one embodiment, at least 51%, at least 52%, at least 53%, at least 55%, at least 60%, at least 65%, at least 70%, at least 75%, at least 80%, at least 85%, at least 90%, or at least 95% of the renewable methane and/or RNG is allocated to the one or more selected hydrogen production units. In one embodiment, 100% of the renewable methane is allocated to the one or more selected hydrogen production units. In one embodiment, each of the selected hydrogen production units is an on-site production unit.

In one embodiment, the method includes allocating at least a portion of the renewable methane and/or RNG to the one or more selected hydrogen production units such that the renewable fraction of feedstock for each of the selected hydrogen production units is higher than the renewable fraction of feedstock for all hydrogen production for the fuel production process.

In one embodiment, the method includes allocating at least a portion of the renewable methane and/or RNG to the one or more selected hydrogen production units such that such that the renewable fraction of feedstock for each of the one or more selected hydrogen production units is higher than the renewable fraction of feedstock directed to a hydrogen production unit (also connected to the pipe system) that (a) is a newer style hydrogen production unit, (b) includes a pressure swing adsorption system, (c) does not include an absorption based hydrogen purification system, (d) does not include a solvent-based hydrogen purification system, (e) fuels the methane reformer with a gas produced by hydrogen purification (e.g., purge gas from a PSA or methane slip from a membrane system), and/or (f) has an energy yield for hydrogen that is not greater than 1 or not greater than 1.1.

Advantageously, allocating the renewable methane and/or RNG to one or more older style hydrogen production units can increase the yield of renewable hydrogen and/or renewable content of the fuel(s) produced.

While some of the advantages of selecting older style hydrogen production units over newer style hydrogen production units have been described, in general, the yield of renewable hydrogen, and thus renewable content, can be increased by preferentially allocating the renewable methane and/or RNG to hydrogen production units that have a higher energy yield (e.g., regardless of whether they are newer or older style hydrogen production units). For example, this approach may be particularly advantageous when the fuel production facility includes hydrogen production units that are not based on SMR, that use a portion of the purge gas from a PSA as feedstock, that only use newer style hydrogen production units, and/or that use new and/or advancing hydrogen purification process.

In one embodiment, the method includes determining an energy yield for hydrogen for each of the hydrogen production units at the fuel production facility (and optionally, to hydrogen production units connected to the fuel production facility), and preferentially allocating the renewable methane and/or RNG (e.g., in MJ./hr) to one or more of these hydrogen production units selected to have a higher energy yield for hydrogen (e.g., higher than the average of all the hydrogen production units at the fuel production facility).

In one embodiment, the fuel production facility includes and/or is connected by a pipe system to multiple hydrogen production units including a first hydrogen production unit comprising a first energy yield, and a second hydrogen production unit comprising a second higher energy yield, and the method includes allocating at least a portion of the renewable methane and/or RNG to the second hydrogen production unit having the higher energy yield such that such that a renewable fraction of feedstock directed and/or allocated to the second hydrogen production unit is higher than a renewable fraction of feedstock directed and/or allocated to the first hydrogen production unit. In one embodiment, the first energy yield is less than 1.1, less than 1.05, less than 1.0, or less than 0.95. In one embodiment, the second energy yield is greater than 1.0, greater than 1.1, greater than 1.2, or greater than 1.3. In one embodiment, the first energy yield is less than 1, and the second energy yield is greater than 1. In one embodiment, the first energy yield is less than 1, and the second energy yield is greater than 1.1. In one embodiment, the first energy yield is less than 1.1, and the second energy yield is greater than 1.2. In one embodiment, the first energy yield is less than 1, and the second energy yield is greater than 1.05. In one embodiment, the first energy yield is less than 1.05, and the second energy yield is greater than 1.1.

While it can be advantageous to allocate the renewable methane to a hydrogen production unit in dependence upon whether it is on-site or off-site and/or older style or newer style unit, additionally, or alternatively, the method can include allocating the renewable methane to hydrogen production units selected using different criteria. For example, in one embodiment, the renewable methane is allocated to one or more hydrogen production units that do not use process gas (in general) to fuel and/or feed the SMR. In these embodiments, all or most of the feedstock and/or fuel for the SMR can be obtained from fresh gas (i.e., gas sourced for the hydrogen production unit(s) and/or the fuel production facility from the natural gas grid or from a CNG or LNG container). Allocating the renewable methane to hydrogen production units that are not fed process gas, which can contain significant quantities of longer hydrocarbons (e.g., light ends), maximizes the amount of renewable hydrogen that can be provided for a given hydrogen production unit. In one embodiment, the renewable methane is allocated to one or more hydrogen production units that have a predetermined minimum throughput (e.g., produce at least 30,000,000 scf/day, at least 40,000,000 scf/day, at least 50,000,000 scf/day, or at least 60,000,000 scf/day, of hydrogen).

In one embodiment, allocating the renewable methane comprises directing the feedstock containing the renewable methane in a pipe system that provides the feedstock only to one or more selected hydrogen production unit (e.g., a dedicated pipe). In one embodiment, allocating the renewable methane comprises providing renewable methane as a fungible batch using a natural gas pipe system connected to a natural gas distribution system.

### Fuel Production

In general, the one or more fuels are produced in a fuel production process using the renewable methane and/or renewable hydrogen. The fuel production process includes one or more hydroprocessing steps wherein crude oil derived liquid hydrocarbon is hydrogenated. The term “crude oil derived liquid hydrocarbon”, as used herein, refers to any carbon-containing material obtained and/or derived from crude oil that is liquid at standard ambient temperature and pressure. The term “crude oil”, as used herein, refers to petroleum extracted from geologic formations (e.g., in its unrefined form). Crude oil includes liquid, gaseous, and/or solid carbon-containing material from geologic formations, including oil reservoirs, such as hydrocarbons found within rock formations, oil sands, or oil shale. Advantageously, since a feedstock for the hydrogen production process and/or the fuel production process contains renewable methane, one or more fuels produced by the process can have renewable content. In one embodiment, the fuel production process produces one or more liquid transportation fuels having renewable content.

In one embodiment, the fuel production process includes producing renewable hydrogen, and adding the renewable hydrogen to the crude oil derived liquid hydrocarbon in a stage in the fuel production process that uses hydrogen (e.g., any unit operation in an oil refinery that requires a hydrogen feed). For example, in one embodiment, the fuel production process includes incorporating renewable hydrogen (which includes hydrogen deemed renewable by regulators) into the hydrocarbon that ultimately is part of one or more fuels produced by the fuel production facility. The incorporation of renewable hydrogen into crude oil derived liquid hydrocarbon encompasses the addition, incorporation, and/or bonding of renewable hydrogen to the crude oil derived liquid hydrocarbon. Such reactions include hydrogenation, which includes, without limitation, any reaction in which renewable hydrogen is added to a crude oil derived liquid hydrocarbon through a chemical bond or linkage to a carbon atom. The renewable hydrogen may be bonded to a carbon backbone, a side chain, or a combination thereof, of a linear or ring compound of a crude oil derived liquid hydrocarbon. The addition and/or incorporation of renewable hydrogen into the crude oil derived liquid hydrocarbon may include the addition of renewable hydrogen to an unsaturated or a saturated hydrocarbon. This includes addition of renewable hydrogen to unsaturated groups, such as alkenes or aromatic groups, on the crude oil derived liquid hydrocarbon (i.e., the saturation of aromatics, olefins (alkenes), or a combination thereof). The addition and/or incorporation of hydrogen may be accompanied by the cleavage of a hydrocarbon molecule. This may include a reaction that involves the addition of a hydrogen atom to each of the molecular fragments that result from the cleavage. Without being limiting, such reactions may include ring opening reactions and/or dealkylation reactions. Such reactions are known to those of skill in the art. The hydrogenation reactions may be conducted in a “hydrogenation reactor”. As used herein, the term “hydrogenation reactor” includes any reactor in which hydrogen is added to a crude oil derived liquid hydrocarbon. Hydrogenation reactions may be carried out in the presence of a catalyst.

In one embodiment, the renewable hydrogen is added to the crude oil derived liquid hydrocarbon in a hydrotreating process. Hydrotreating processes typically use hydrogen, under pressure, in the presence of a catalyst, to remove oxygen and/or other heteroatoms (e.g., nitrogen, sulfur, halides, and metals) from crude oil derived liquid hydrocarbon. For example, hydrotreaters may be used to remove sulfur and other contaminants from intermediate streams before blending into a finished refined product. At high pressures, hydrotreaters may also saturate aromatics and olefins. Although hydrotreating may saturate olefinic and aromatic bonds, there is minimal cracking. For example, a minimal conversion of 10-20% may be typical. Without being limiting, hydrotreaters may be operated at temperatures between 290-455° C. and at pressures between 150 psig (1.03 MPa)-2000 psig (13.79 MPa), in the presence of a metal catalyst (e.g., CoMo/Al₂O₃ or NiMo/Al₂O₃). The conditions used in a hydrotreater are conventional and can be readily selected by those of ordinary skill in the art.

In one embodiment, the renewable hydrogen is added to the crude oil derived liquid hydrocarbon in a hydrocracking process. Hydrocracking processes typically use hydrogen, under pressure, in the presence of a catalyst, to convert relatively high-boiling, high molecular weight hydrocarbons into lower-boiling, lower molecular weight hydrocarbons by breaking carbon-to-carbon bonds. The breaking of carbon-to-carbon bonds, also referred to herein as “cracking”, may be carried out in a hydrocracker. Without being limiting, hydrocrackers may be operated at temperatures between 400-800° C. and at pressures between 1000 psig (6.89 MPa)-2000 psig (13.79 MPa), in the presence of a catalyst. Catalysts used for hydrocracking may be bifunctional, and more specifically, may provide a hydrogenation function provided by a metal (e.g., Pt, Pd), and an acid function, which catalyzes the cracking, provided by the support (e.g., zeolite). In one embodiment, the hydrocracker uses a catalyst that is active only for cracking and hydrogenating. In contrast to hydrotreating, which may provide a conversion level less than about 20 wt % (and more typically less than 15 wt %), a hydrocracker may provide a conversion level that is between 20 and 100 wt %. By the term “conversion level”, it is meant the difference in amount of unconverted crude oil derived liquid hydrocarbon between feed and product divided by the amount of unconverted crude oil derived liquid hydrocarbon in the feed. Unconverted crude oil derived liquid hydrocarbon is material that boils above a specified temperature. Without being limiting, for vacuum gas oil, a typical specified temperature may be 343° C. The conditions used in hydrocrackers are conventional and can be readily selected by those of ordinary skill in the art.

In one embodiment, the renewable hydrogen is added to the crude oil derived liquid hydrocarbon in a hydroprocessing process that includes hydrogenation, hydrocracking, and/or hydrodesulfurization. In a conventional oil refinery, there may be multiple hydroprocessing unit operations that consume hydrogen at individual rates, purities, and pressures. The hydrogen fed to these hydroprocessing units may be obtained from a variety of sources, each of which provides hydrogen at individual rates, purities, pressures, and costs. For example, in addition to the hydrogen production unit (which may be on-site or off-site), one common source of hydrogen in an oil refinery is the catalytic reformer used to produce high octane reformate from naphtha. Another source may be from gasification/partial oxidation of oil. A pipe system for the oil refinery may distribute hydrogen gas from the various supply sources to the various consumption sites. Integrated into this complex pipe system are controls that alter, among other things, the flow rate, purity and/or pressure of hydrogen.

In one embodiment, the fuel production facility includes one or more pipes that provide hydrogen (e.g., in gaseous or liquid form) to multiple unit operations and/or processing units. In one embodiment, hydrogen fed into these pipes must meet certain specifications (e.g., meet a certain quality threshold in terms of purity). For example, the fuel production facility may include more than one pipe, each of which provides hydrogen of a different quality (e.g., high quality from the hydrogen production unit or lower quality from recycle streams). In one embodiment, these pipes are part of the pipe system that provides renewable hydrogen. In one embodiment, the renewable hydrogen is provided as a fungible batch or segregated batch to one or more unit operations and/or processing units using the pipe system. In general, each pipe in the pipe system may provide only renewable hydrogen, only fossil hydrogen, or a mixture of renewable hydrogen and fossil hydrogen. The term “fossil hydrogen”, as used herein, refers to hydrogen produced from fossil fuels and not produced from renewable methane.

In one embodiment, the renewable hydrogen is directed and/or allocated within the fuel production facility (e.g., at an oil refinery) such that it preferentially ends up in one or more predetermined fuel products and/or is preferentially consumed in one or more predetermined unit operations.

In one embodiment, the renewable hydrogen is directed and/or allocated within the fuel production facility such that it preferentially ends up in gasoline or a gasoline blending component. The term “gasoline” refers generally to a liquid fuel or liquid fuel component suitable for use in spark ignition engines (e.g., which may be predominantly C₅-C₉ hydrocarbons, and which may boil in the range between 32° C. and 204° C.). In one embodiment, the renewable hydrogen is directed within the fuel production facility such that it ends up in a product that satisfies applicable gasoline specifications (e.g., ASTM D4814).

In one embodiment, the renewable hydrogen is directed within the fuel production facility (e.g., at an oil refinery) such that it preferentially ends up in diesel or a diesel blending component. The term “diesel” refers generally to a liquid fuel or liquid fuel component suitable for use in compression ignition engines (e.g., which may be predominantly C₉-C₂₅ hydrocarbons, and which boils in the range as known to those skilled in the art, e.g., between 187° C. and 417° C.). In one embodiment, the renewable hydrogen is directed and/or allocated within the fuel production facility such that it ends up in a product that satisfies applicable diesel specifications (e.g., ASTM D975).

In one embodiment, the renewable hydrogen is directed and/or allocated within the fuel production facility (e.g., at an oil refinery) such that the percentage of renewable hydrogen that ends up in diesel is at least 1.1, 1.2, 1.3, 1.4, or 1.5 times the percentage of fuel produced by the refinery that is diesel. For example, if the fuel production facility produces about 40% diesel and 60% gasoline, more than 44%, 48%, 52%, 56% or 60% of the renewable hydrogen ends up in diesel or diesel blending components.

In one embodiment, the renewable hydrogen is allocated to predetermined unit operations and/or processing units (e.g., to a single unit operation and/or processing unit, or to multiple unit operations and/or processing units).

In one embodiment, the renewable hydrogen is allocated to one or more hydrotreaters at the fuel production facility. An oil refinery typically has multiple hydrotreaters. For example, an oil refinery may include a naphtha hydrotreater (e.g., treats heavy naphtha prior to reforming), a kerosene hydrotreater (e.g., removes sulfur and improves smoke point of kerosene), a diesel hydrotreater (e.g., removes sulfur and nitrogen and increases the cetane number of diesel), a vacuum gas oil (VGO) hydrotreater, and/or a resid hydrotreater (e.g., to treat atmospheric residue or vacuum residue). An oil refinery may also include a distillate hydrotreater that improves the quality of distillate boiling range feedstocks (e.g., uses a feed that includes crude oil derived liquid hydrocarbon in the kerosene and diesel boiling point range). In general, a distillate hydrotreater can treat an individual distillate fraction or a mixture of various distillate fractions, as well as other refinery streams, to meet specifications required for the finished fuel (e.g., sulfur and/or cetane number specifications).

In one embodiment, the renewable hydrogen is allocated to one or more hydrocrackers at the fuel production facility. In an oil refinery, hydrocrackers may be used to process gas oil, aromatic cycle oils, and/or coker distillates. These feeds may originate from atmospheric and/or vacuum distillation units, delayed cokers, fluid cokers, visbreakers, or fluid catalytic cracking units. Middle distillates from a hydrocracker usually meet or exceed finished product specifications, but the heavy naphtha from a hydrocracker may be sent to a catalytic reformer for octane improvement. In general, hydrocrackers may be the largest hydrogen consumer in an oil refinery. Using the renewable hydrogen in a hydrocracking process exploits this high demand, and may be advantageous in that more renewable hydrogen may be physically incorporated into the fuel (relative to using the renewable hydrogen in a hydrotreating process for desulfurization where a portion of the renewable hydrogen may be converted to hydrogen sulfide). In one embodiment, the renewable hydrogen is allocated to a hydrocracker that produces more diesel than gasoline (i.e., on a volume basis).

In some embodiments, even when all of the renewable hydrogen is allocated to a single unit operation, the renewable hydrogen may end up in multiple products and/or coproducts. For example, consider the case where a batch of renewable hydrogen is used in a unit operation that provides cracking (e.g., in a hydrocracker, or in a hydrotreater upstream of a cat cracker), which breaks the longer crude oil derived liquid hydrocarbons chains into smaller molecules, and then separates the product according to boiling point in a distillation tower. In this case and others, the renewable hydrogen may be incorporated into hydrogen sulfide, LPG, gasoline, kerosene/jet, diesel/heating oil, etc. In some embodiments, the fuel production process may include allocating the renewable content (e.g., by energy) to one or more of the fuel products. In one embodiment, the renewable content is allocated to all of the products. In one embodiment, the renewable content is allocated only to qualifying fuels (i.e., fuels that qualify for incentives under applicable regulations). In one embodiment, the renewable content is allocated to only one qualifying fuel. In one embodiment, the renewable content is allocated to all products equally. In one embodiment, the renewable content is allocated to each product proportionally to how much is produced. In one embodiment, the renewable content is allocated to each product proportionally to how much hydrogen is incorporated therein. In general, the approach used to allocate the renewable content to fuel products may be dependent on the applicable regulations and/or the authority providing incentives, and thus may be dependent upon where the fuel is produced and/or sold.

In one embodiment, the method includes providing a volume of fuel having renewable content. In one embodiment, the fuel is a liquid transportation fuel or a blending component for a liquid transportation fuel. In one embodiment, the fuel is gasoline or a gasoline blending component, jet fuel or a jet fuel blending component, or diesel or a diesel blending component.

### Quantifying the Renewable Content

In one embodiment, the method includes quantifying the renewable content of the fuel(s) produced. In general, quantifying the renewable content in the fuel includes determining how much renewable content (e.g., by volume, mass, or energy) is in an amount of the fuel produced (e.g., a batch, which may be expressed as volume, mass, or energy). The renewable content of a fuel typically will be measured and/or calculated using a methodology that is accepted by the applicable regulations (e.g., for fuel credit generation) and can, for example, include allocating some or all of the energy content of the renewable methane or RNG used as feedstock for hydrogen production to the fuel.

In one embodiment, the renewable content is measured as a mass % (i.e., mass of renewable hydrogen in a batch per total mass of the batch, expressed as a percentage). In one embodiment the renewable content is measured as kg of renewable hydrogen/barrel of fuel. In one embodiment, the renewable content is measured as a volume % (i.e., volume of renewable hydrogen in a batch per total volume of the batch, expressed as a percentage). In one embodiment the renewable content is measured as L of renewable hydrogen/barrel of fuel. In one embodiment, the renewable content is measured as an energy percentage (i.e., energy of renewable hydrogen in a batch per total energy of the batch). In one embodiment, the renewable content is quantified using one of the approaches described in U.S. Ser. No. 62/892123, filed Aug. 27, 2019, which is hereby incorporated by reference.

In one embodiment, the renewable content is measured using a mass balance or energy content approach. Mass balance and energy content approaches to determining renewable content, which can include calculation methods based on chemical reactions in the refining unit, typically require measurements to be taken prior to the start of the process and thereafter (i.e. monitoring of input and output mass or energy content).

In one embodiment, the renewable content of the fuel(s) produced is quantified using energy. For example, in one embodiment, the yield of renewable content (in energy units) for the production of a given fuel is given as

Yield of renewable content (in energy units)=renewable fraction of feedstock*energy of fuel produced (5)

wherein the renewable fraction of feedstock is calculated using energy. In general, the yield of renewable content for a particular fuel can be dependent on the process boundaries used (e.g., the feedstock(s) used and the product(s) produced) and/or how the energy of the renewable hydrogen is allocated.

In one embodiment, the renewable content is quantified using the renewability, as proposed in the “RTFO Guidance Part One Process Guidance”, version January 2020, used for reporting under the Renewable Transport Fuel Obligations Order 2007 No. 3072. In this case, the renewability of a fuel refers to the percentage of a fuel (by energy) that is recognized as and/or qualifies as renewable, and can be calculated using Eq. (6).

$$MJ of renewable fuel = \frac{Total MJ of renewable feedstocks}{Total MJ of all feedstocks} * Total MJ of fuel produced \qquad ( 6 )$$

In general, using renewability to quantify the renewable content of one or more fuels produced from a feedstock containing renewable methane and a feedstock containing crude-oil derived liquid hydrocarbon may be particularly suitable as part of the energy of the fuel is from renewable sources (e.g., biogas) and part is from non-renewable sources. In the fuel production process described herein, some non-limiting examples of feedstocks for producing the one or more fuels include natural gas, crude oil, hydrogen, and/or unfinished oils.

Further advantageously, since a fuel produced from such a process may not have discrete volumes that are renewable or non-renewable, the renewability of the fuel can be used to split the volume of the fuel(s) produced into notional non-renewable and renewable portions and/or to re-assign the renewable content between different consignments of the same fuel or fuel component. This is particularly advantageous when at least part of the fuel is to be shipped and/or when the renewable content of a fuel is required to meet a target value in order to qualify for incentives.

Since allocating the renewable methane and/or RNG to selected hydrogen production units can increase the relative amount of renewable hydrogen provided (by energy) and/or the renewable content of the fuel, this approach can produce higher volumes of renewable content. In some cases (e.g., if it meets applicable sustainability criteria), the renewable portion of a fuel (i.e., the renewable content) may be eligible for fuel credits (e.g., Renewable Transport Fuel Certificates or RTFCs). In addition, since some fuel credits are dependent on the carbon intensity of the fuel, and since increasing the renewable content can decrease the carbon intensity, more incentives may be available.

In one embodiment, the calculated renewable content is dependent on the renewable methane and/or RNG being allocated to selected hydrogen production units, where the selected hydrogen production units includes an on-site hydrogen production unit selected over an off-site hydrogen production unit and/or an older style hydrogen production unit selected over a newer style hydrogen production unit.

In one embodiment, wherein quantifying the renewable content includes using energy of the feedstock(s) and/or product(s), the process includes determining an amount of renewable methane and/or RNG directed to the selected hydrogen production units (e.g., in MJ) and/or an amount of renewable hydrogen directed to each of the one or more hydroprocessing units in energy units (e.g., in MJ), determining an amount of crude oil derived liquid hydrocarbon fed into each of the one or more hydroprocessing units in energy units (e.g., MJ), and determining an amount of at least one product produced by each of the one or more hydroprocessing units in energy units (e.g., MJ). The amount of feedstock/product provided/produced in energy units (e.g., MJ) can be determined from the corresponding mass (or volume) flow over a given time period multiplied by the corresponding heating value (e.g., LHV).

Determining the energy (e.g., MJ) of the feedstock(s) and/or product(s) typically includes measuring a flow (e.g., mass flow rate, volume flow rate, daily average mass flow rate, daily average volume flow rate, average mass flow rate for a reporting period, and/or average volume flow rate for a reporting period). For example, determining the energy of the renewable hydrogen feedstock typically includes measuring a flow rate (e.g., volume flow rate) of hydrogen into the selected unit operations or processing units (e.g., using a gas meter). The energy of the renewable hydrogen feedstock may be determined using the flow rate of hydrogen into the selected unit operations and/or processing units and the ratio of renewable hydrogen to fossil hydrogen.

In general, measuring the flow of the feedstock(s) and/or products may be achieved using any suitable method/technology in the art. In one embodiment, the flow of feedstock(s) and/or product(s) is measured as a volume flow rate and/or a mass flow rate, using a suitable flow meter, either continuously or intermittently. In one embodiment, measuring the flow of feedstock(s) and/or products includes measuring the flow of feedstock into the unit operation/processing unit. As will be understood by those skilled in the art, the frequency of sampling required may depend on how (or if) the values change over time and/or with variabilities in the process conditions (e.g., feedstock).

Advantageously, the method can include or enable generating or causing the generation of a fuel credit. In one embodiment, the fuel credit is generated in dependence upon the renewable methane and/or renewable hydrogen being used to produce the fuel. In one embodiment, a fuel credit is generated in dependence upon the renewable hydrogen being incorporated into the fuel. In one embodiment, a fuel credit is generated in dependence upon a calculated renewable content of the fuel product. In one embodiment, the fuel credit is generated in dependence upon a magnitude of carbon intensity of the renewable content (i.e., of the renewable hydrogen). In one embodiment, the process includes generating, or causing the generation of, a fuel credit for the renewable portion of the fuel (i.e., the renewable content).

In one embodiment, a renewable fuel credit is generated in dependence upon the renewable hydrogen being used to produce a liquid transportation fuel, where the renewable fuel credit is a certificate, record, serial number or guarantee, in any form, including electronic, which evidences production of a quantity of fuel meeting certain lifecycle greenhouse gas emission reductions relative to a baseline set by a government authority. Non-limiting examples of credits include RINs and LCFS credits. A Renewable Identification Number (or RIN) is a certificate that acts as a tradable currency for managing compliance under the Renewable Fuel Standard (RFS) in the US. A Low Carbon Fuel Standard (LCFS) credit is a certificate which acts as a tradable currency for managing compliance under California's LCFS. A RIN has numerical information associated with the production of a qualifying renewable fuel in accordance with regulations administered by the EPA for the purpose of managing the production, distribution and use of renewable fuels for transportation or other purposes. In one embodiment, the process of producing the fuel includes generating or causing the generation of LCFS credits. In general, the requirements for generating or causing the generation of fuel credits can vary by country, the agency, and or the prevailing regulations in/under which the fuel credit is generated.

### Providing the Fuel Having Renewable Content

In general, the method includes provides one or more fuels having renewable content. In one embodiment, each of the one or more fuel(s) is a finished fuel (e.g., finished gasoline, finished diesel, finished jet fuel, etc.). The term “finished fuel”, as used herein, refers to a mixture of hydrocarbons with or without small quantities of additives, blended to form a fuel suitable for an intended use (e.g., for use in spark-ignition engines or diesel engines). In one embodiment, the fuel provided is a fuel component for blending, which may be used to provide a finished fuel and/or fuel composition. The term “fuel component” or “blending component”, as used herein, refers to any compound or mixture of compounds that is used to formulate a finished fuel or fuel composition. For example, some examples of fuel components include naphtha, kerosene, light gasoil, etc. While a finished fuel may or may not contain small quantities of additives, a fuel composition typically includes one or more additives such as flow improvers, cloud point depressants, antifoam additives, drag reducing additives, stabilizers, corrosion inhibitors, ignition improvers, smoke suppressants, combustion catalysts, etc. The term “fuel”, as used herein, encompasses finished fuels, blending components, and fuel compositions.

In one embodiment, the method includes providing a volume of a fuel having renewable content (e.g., a liquid transportation fuel or blending component of a liquid transportation fuel), where the volume, the renewable content, or a combination thereof is dependent on a calculated renewable content. For example, consider the case where the fuel production process produces a diesel blending component having a calculated renewable content of 20% (e.g., a renewability of 20%). In this case, ⅕ of a barrel of the diesel blending component can qualify as a renewable fuel, while the remaining ⅘ of the barrel is non-renewable. If the renewable content of the diesel blending component is re-assigning between different consignments, then the fuel production process can produce:
a) 5 barrels of diesel blending component that is 20% renewable;
b) 1 barrel of diesel blending component that that is 100% renewable and 4 barrels of diesel blending component that is non-renewable; or
c) 4 barrels of diesel blending component that is 25% renewable and 1 barrel of diesel blending component that is non-renewable.
Alternatively, the method can include providing a barrel of finished diesel containing the diesel blending component having renewable content.

In one embodiment, the method includes providing a volume of fuel having renewable content, where the renewable content is less than 100% (e.g., between 1% and 99%, between 2% and 90%, between 3% and 80%, between 4% and 70%, between 50% and 99%, between 15% and 99%, between 20% and 99%, between 25% and 99%, or between 30% and 99%). In one embodiment, the method includes providing a volume of fuel having renewable content, where the renewable content is at least 25%, at least 30, or at least 35%. In one embodiment, the method includes providing a volume of fuel having renewable content, where the renewable content is about 100%.

In one embodiment, the renewable content of the fuel(s) produced has lifecycle greenhouse gas emissions that are at least 50%, at least 60%, at least 65%, or at least 70% lower than lifecycle greenhouse gas emissions of a remaining portion of the fuel composition.

Advantageously, the calculated renewable content and/or carbon intensity of the fuel(s) produced are calculated in dependence upon the renewable methane and/or RNG being allocated to selected hydrogen production units, the volume of the renewable content provided can be increased and/or the carbon intensity can be reduced.

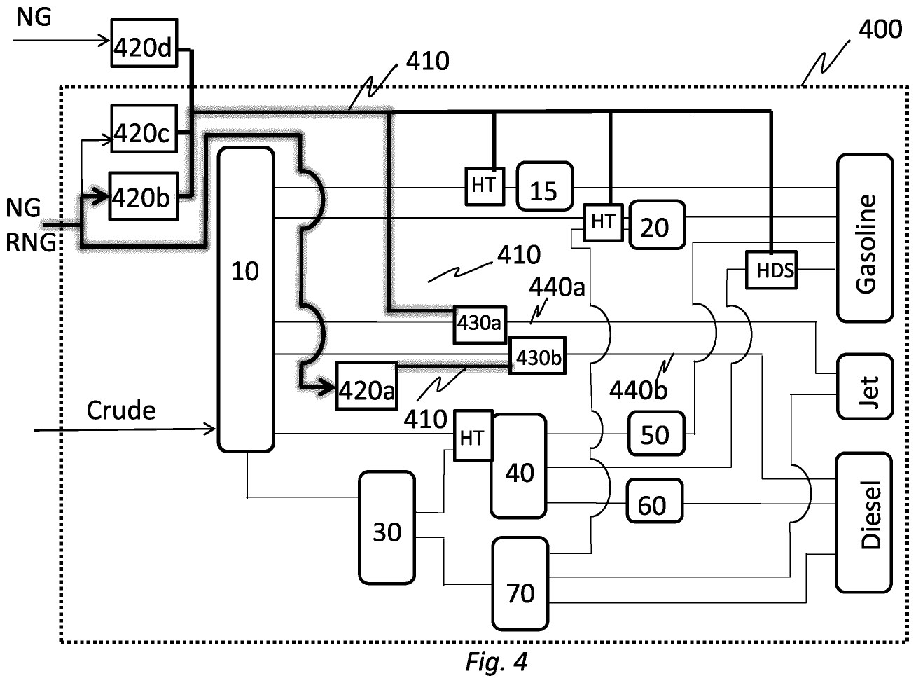

Referring to FIG. 4, there is shown a system for producing one or more fuels having renewable content in accordance with one embodiment of the invention. The one or more fuels are produced at a fuel production facility 400 having a pipe system 410 configured to convey hydrogen produced by multiple hydrogen production units 420a, 420b, 420c, 420d (and optionally hydrogen produced within the fuel production process). Two of the hydrogen production units 420a, 420b are older style hydrogen production units, while the other two 420c and 440d are newer style hydrogen production units. The process includes providing RNG (e.g., derived from biogas) for use in the fuel production facility 400, allocating at least a portion of the RNG to one or more selected hydrogen production units 420a, 420b selected from the multiple hydrogen production units connected to the pipe system 410, conveying hydrogen produced at the selected hydrogen production units within the fuel production facility using the pipe system 410, and feeding at least a portion of the hydrogen to one or more hydroprocessing systems. In general, the renewable hydrogen produced by the selected hydrogen production unit(s) can be allocated equally, proportionally, or selectively to hydroprocessing units connected thereto. In FIG. 4, the renewable hydrogen produced at hydrogen production units 420b and 420a is illustrated as being allocated to hydroprocessing units 430a and 430b, respectively. Accordingly, crude oil derived liquid hydrocarbon fed into these hydroprocessing units produces one or more fuels 440a, 440b having renewable content.

In the embodiment illustrated in FIG. 4, the hydrogen for the hydroprocessing system 430a can be produced from the hydrogen production units labelled 420b, 420c, and/or 420d. However, in allocating the RNG to the older-style, on-site hydrogen production unit 420b, the kerosene product 440a can have a relatively high renewable content and/or a relatively low CI (i.e., relative to if the RNG is allocated to the off-site, newer style hydrogen production unit 420d), for a given quantity of RNG used as feedstock. In another embodiment, the RNG is allocated to the older-style, on-site hydrogen production unit such that one or more other products (e.g., diesel) can have a relatively high renewable content and/or a relatively low CI.

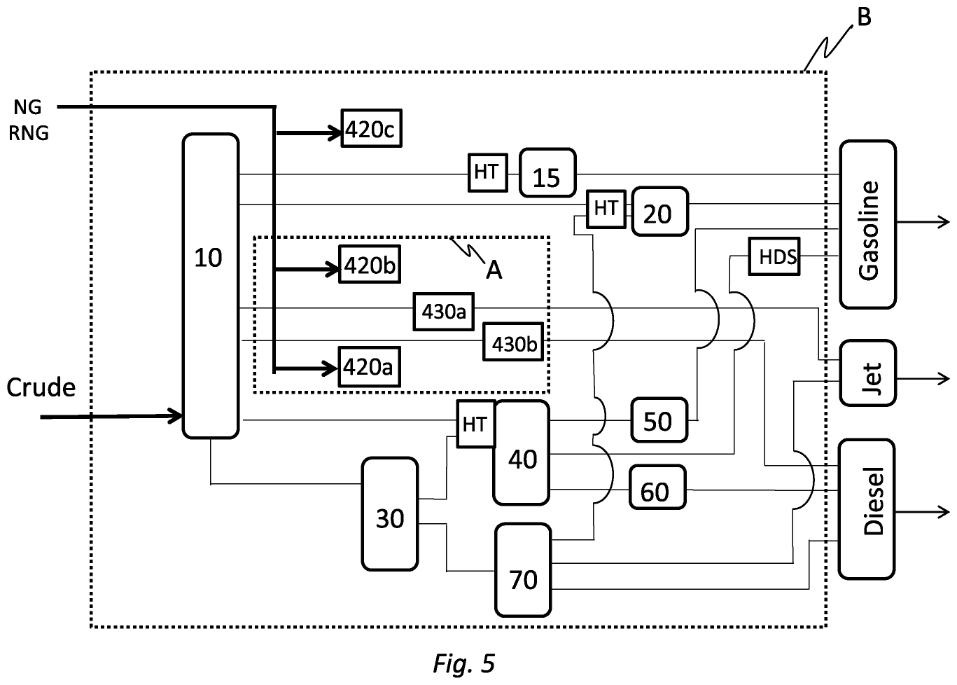

Advantageously, since the fuels and/or the renewable content may be recognized as and/or qualify as a renewable fuel under applicable regulations, one or more fuel credits can be generated. In one embodiment, the process includes determining the renewable content of the one or more fuels provided 440a, 440b and/or generating fuel credits for the fuel and/or the renewable content. The renewable content of the fuel(s) produced, and thus the number and/or value of fuel credits generated, can be dependent on the boundary of the fuel production process. For example, in the configuration illustrated in FIG. 5, the feedstock and/or products change depending on whether the fuel production process is defined by the box labeled A, or the box labeled B.

Providing a system for producing one or more fuels having renewable content, wherein the system is a subset of the fuel production facility (e.g., a subset of an oil refinery) can be advantageous. In one embodiment, the method includes selecting one or more hydrogen production units and one or more hydroprocessing units at the oil refinery to provide a system for producing one or more fuels having renewable content, wherein the hydrogen production units are selected to increase a yield of renewable content of one or more of the fuels and/or reduce a carbon intensity of one or more of the fuels for a given quantity of renewable methane. In this embodiment, the process of producing one or more fuels having renewable content includes allocating RNG provided to the oil refinery such that natural gas fed into the system (i.e., the subset of the oil refinery) and used for hydrogen production has a higher renewable fraction than natural gas fed to a hydrogen production unit at the oil refinery that is not in the system.

Of course, the above embodiments have been provided as examples only. It will be appreciated by those of ordinary skill in the art that various modifications, alternate configurations, and/or equivalents will be employed without departing from the scope of the invention. Accordingly, the scope of the invention is therefore intended to be limited solely by the scope of the appended claims.

1. A method of producing one or more fuels having a renewable content, the method comprising:
(a) providing renewable methane;
(b) producing one or more fuels from a fuel production process that comprises one or more processing steps wherein hydrogen is reacted with crude oil derived liquid hydrocarbon, said hydrogen produced by methane reforming a feedstock comprising methane, said methane reforming conducted in a plurality of hydrogen production units;
(c) selecting one or more hydrogen production units from the plurality of hydrogen production units such that there are one or more selected hydrogen production units having one or more hydrogen-producing characteristic and one or more other hydrogen production units that do not have the one or more hydrogen-producing characteristics;
(d) allocating the renewable methane among the plurality of hydrogen production units such that a renewable fraction of the feedstock comprising methane for the one or more selected hydrogen production units is greater than a renewable fraction of feedstock comprising methane for the one or more other hydrogen production units; and
(e) providing a volume of a fuel produced from the fuel production process, said fuel comprising renewable content,
wherein the selecting step comprises selecting hydrogen production units to increase a yield of renewable content of the fuel provided in (e), reduce a carbon intensity of the fuel provided in (e) for a given quantity of renewable methane, or a combination thereof, wherein the increase in yield of renewable content, reduction in carbon intensity, or combination thereof, is relative to the yield of renewable content of the fuel, the reduction in carbon intensity of the fuel, or a combination thereof, if there is no differentiation between the allocation of the renewable methane between the plurality of hydrogen production units.

2. The method according to claim 1, wherein the allocating step comprises allocating the renewable methane such that the renewable fraction of the feedstock comprising methane for the one or more selected hydrogen production units is greater than a renewable fraction of feedstock comprising methane for all hydrogen production for the fuel production process.

3. The method according to claim 1, wherein the one or more hydrogen-producing characteristics include an on-site location, and wherein at least one of the one or more other hydrogen production units is an off-site hydrogen production unit.

4. The method according to claim 1, wherein the one or more hydrogen-producing characteristics includes not combusting off-gas to produce heat for the methane reforming, and wherein each of the one or more other hydrogen production units combusts off-gas to produce heat for the methane reforming.

5. The method according to claim 1, wherein the one or more hydrogen-producing characteristics includes no adsorption-based hydrogen purification and each of the one or more selected hydrogen production units does not comprise a pressure swing adsorption system, and wherein each of the one or more other hydrogen production units comprises a pressure swing adsorption system.

6. The method according to claim 1, wherein the one or more hydrogen-producing characteristics include absorption-based hydrogen purification and each of the one or more selected hydrogen production units comprises an absorption system, and wherein each of the one or more other hydrogen production units comprises an adsorption system.

7. The method according to claim 1, wherein the one or more hydrogen-producing characteristics includes having an energy yield for hydrogen of at least 1.1, and wherein each of the one or more other hydrogen production units has an energy yield for hydrogen that is less than 1.1.

8. The method according to claim 1, wherein the one or more hydrogen-producing characteristics includes having an energy yield for hydrogen that is greater than an average energy yield of hydrogen of the plurality of hydrogen production units.

9. The method according to claim 1, wherein the average energy yield for hydrogen of the one or more selected hydrogen production units is higher than the average energy yield for hydrogen of the one or more other hydrogen production units.

10. The method according to claim 1, wherein at least 60% of the renewable methane provided in step (a) is allocated to hydrogen production units that do not combust off-gas to produce heat for the methane reforming.

11. The method according to claim 1, wherein less than 40% of the renewable methane provided in step (a) is provided to off-site hydrogen production units.

12. The method according to claim 1, further comprising determining an energy yield for hydrogen for each hydrogen production unit in the plurality of hydrogen production units, and wherein the allocating step comprises allocating the renewable methane in dependence upon the determined energy yields for hydrogen.

13. The method according to claim 12, wherein the selecting step comprises selecting a hydrogen production unit having the highest determined energy yield among the hydrogen production units in the plurality of hydrogen production units.

14. The method according to claim 1, further comprising calculating a renewable content dependent on the allocating step (d), and wherein the volume of the fuel provided in step (e), the renewable content of the volume of fuel provided in step (e), or a combination thereof, is dependent on the calculated renewable content.

15. The method according to claim 1, wherein the allocating step comprises allocating at least 75% of the renewable methane provided in step (a) to the one or more selected hydrogen production units.

16. The method according to claim 1, wherein the hydrogen in step (b) is produced by steam methane reforming the feedstock comprising methane, said steam methane reforming conducted in the plurality of hydrogen production units.

17-19. (canceled)

20. The method according to claim 1, comprising determining a carbon intensity of the fuel provided in step (e), wherein the carbon intensity is dependent on the allocation of renewable methane among the hydrogen production units in the allocating step (d).

21. The method according to claim 1, wherein the at least one fuel comprises diesel, gasoline, or jet fuel, or any combination thereof.

22. The method according to claim 1, comprising sequestering carbon dioxide removed from syngas or shifted gas produced by the methane reforming.

23. (canceled)

24. A method of producing one or more fuels comprising:
(a) providing a feedstock comprising natural gas, a fraction of which is renewable natural gas;
(b) producing one or more fuels in a fuel production process, said fuel production process comprising one or more processing steps wherein hydrogen is reacted with crude oil derived liquid hydrocarbon, said hydrogen produced by providing the feedstock to a plurality of hydrogen production units;
(c) allocating the renewable natural gas as feedstock to one or more hydrogen production units in the plurality of hydrogen production units, wherein allocating the renewable natural gas comprises preferentially allocating the renewable natural gas to hydrogen production units that do not comprise a pressure swing adsorption system over hydrogen production units that include a pressure swing adsorption system, preferentially allocating the renewable natural gas to on-site hydrogen production units over off-site hydrogen production units, or a combination thereof; and
(d) providing a fuel having renewable content, said renewable content quantified in dependence upon the allocating in step (c).

25. A method of producing one or more fuels comprising:
(a) providing a feedstock for a fuel production process that produces one or more fuels, said feedstock comprising natural gas, a fraction of which is renewable natural gas, said fuel production process comprising one or more processing steps wherein hydrogen is reacted with crude oil derived liquid hydrocarbon, said hydrogen produced by methane reforming in a plurality of hydrogen production units, said plurality of hydrogen production units comprising an off-site hydrogen production unit, a hydrogen production unit comprising a pressure swing adsorption system, or a combination thereof;
(b) producing one or more fuels from the fuel production process using the feedstock;
(c) allocating the renewable natural gas to one or more selected hydrogen production units in the plurality of production units such that a renewable fraction of the feedstock fed to each of the one or more selected hydrogen production units is greater than a renewable fraction of feedstock for all hydrogen production for the fuel production process, wherein the one or more selected hydrogen production units include an on-site hydrogen production unit, a hydrogen production unit comprising an absorption-based hydrogen purification system, or combination thereof;
(d) providing a volume of a fuel produced from the fuel production process, said fuel comprising renewable content, wherein the volume of the fuel, the renewable content, or a combination thereof is dependent on which hydrogen production units are selected from the plurality of hydrogen production units.

26-28. (canceled)
